(19) United States
(12) Patent Application Publication
(10) Pub. No.: US 2024/0417271 A1
(43) Pub. Date: Dec. 19, 2024

(54) CALCIUM CARBONATE MINERALIZATION OF HEMP FIBER

(71) Applicant: North Carolina State University, Raleigh, NC (US)

(72) Inventors: Ericka N. Ford, Raleigh, NC (US); Md Shakirul Islam, Raleigh, NC (US); Hajara Babayo, Raleigh, NC (US)

(73) Assignee: North Carolina State University, Raleigh, NC (US)

(21) Appl. No.: 18/742,685

(22) Filed: Jun. 13, 2024

Related U.S. Application Data
(60) Provisional application No. 63/472,792, filed on Jun. 13, 2023.

(51) Int. Cl. C01F 11/18; C04B 7/02; C08L 1/02

(52) U.S. Cl. CPC C01F 11/181; C04B 7/02; C08L 1/02

(57) ABSTRACT

Methods of mineralizing hemp fiber to provide hemp fibers mineralized with calcium carbonate are described. Also described are mineralized hemp fibers and compositions including the mineralized hemp fibers. The mineralized hemp fibers can be hemp fibers with calcium carbonated deposited on the hemp fiber surface. The compositions including the mineralized hemp fibers can be cementitious or non-cementitious. Also described are methods of preparing “green” concrete comprising mineralized hemp.

### CROSS REFERENCE TO RELATED APPLICATIONS

This application claims benefit of and priority to U.S. Provisional Patent Application Ser. No. 63/472,792, filed Jun. 13, 2023, the disclosure of which is incorporated herein by reference in its entirety.

### TECHNICAL FIELD

The presently disclosed subject matter relates to methods of mineralizing hemp fibers. The presently disclosed subject matter can also relate to mineralized hemp fibers and compositions comprising the mineralized hemp fibers. The mineralized hemp fibers can comprise hemp fibers with calcium carbonate deposited on the surface of the hemp fiber. The compositions include both cementitious and non-cementitious compositions. In addition, the presently disclosed subject matter relates to methods of preparing “green” concrete.

### BACKGROUND

There is a growing interest in advanced renewable and sustainable bio-based materials among the scientific and industrial communities.¹ Among these materials are organic/inorganic hybrid fibers (OIHFs), which are a type of flexible pseudo-1D material with a high aspect ratio and distinct organic/inorganic domains.² These hybrids include at least two components that are merged at the molecular or nanometer level, resulting in materials that can exhibit desirable properties of both organic polymers (e.g., toughness, elasticity, and formability) and inorganic constituents (e.g., hardness, strength, and chemical resistance).³⁻⁵ These hybrids can be customized to create multifunctional materials suitable for a wide range of applications.^{3,6}

However, there remains an ongoing need for additional methods of preparing OIHFs that are efficient for large scale production, as well as for additional OIHFs themselves. In particular, there is an ongoing need for OIHFs that are based on natural fibers, as well as for OIHFs that can be used in applications such as in the production of cementitious and non-cementitious construction materials.

### SUMMARY

This summary lists several embodiments of the presently disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this summary or not. To avoid excessive repetition, this Summary does not list or suggest all possible combinations of such features.

In some embodiments, the presently disclosed subject matter provides a method of mineralizing a hemp fiber, wherein the method comprises: (a) providing a hemp fiber for mineralization; and (b) sequentially treating the hemp fiber with two aqueous solutions, wherein one of the two aqueous solutions comprises a calcium halide and wherein another of the two aqueous solutions comprises an alkali metal carbonate; thereby providing a hemp fiber mineralized with calcium carbonate. In some embodiments, providing a hemp fiber comprises providing a decorticated hemp fiber. In some embodiments, providing the hemp fiber comprises providing a degummed hemp fiber. In some embodiments, providing the hemp fiber comprises opening, carding, or opening and carding the hemp fiber.

In some embodiments, the alkali metal carbonate is selected from sodium carbonate (Na₂CO₃), potassium carbonate (K₂CO₃), or cesium carbonate (Cs₂CO₃) and/or wherein the calcium halide is calcium chloride (CaCl₂).

In some embodiments, sequentially treating the hemp fiber with the two aqueous solutions comprising sequentially spraying the hemp fiber with the two aqueous solutions or sequentially dipping the hemp fiber into the two aqueous solutions. In some embodiments, sequentially treating the hemp fiber with the two aqueous solutions comprises: (b1) spraying the hemp fiber with the aqueous solution comprising the calcium halide, optionally about 140 millimolar (mM) CaCl₂, for a first period of time, optionally about 2 seconds to about 60 seconds; (b2) waiting for a second period of time, optionally about 20 to 30 seconds; (b3) spraying the hemp fiber with the aqueous solution comprising the alkali metal carbonate, optionally about 140 mM alkali metal carbonate, for a third period of time, optionally about 2 seconds to about 60 seconds; (b4) waiting for a fourth period of time, optionally about 20 to 30 seconds; and (b5) drying the hemp fiber for a fifth period of time, optionally for at least about 8 hours; optionally wherein the hemp fiber is positioned on a screen for steps (b1)-(b4) to allow the solutions to drain off the hemp fiber during the second and fourth periods of time.

In some embodiments, the presently disclosed subject matter provides a mineralized hemp fiber, wherein said mineralized hemp fiber comprises a cellulosic hemp fiber further comprising a coating comprising calcium carbonate deposited on the surface of the cellulosic hemp fiber. In some embodiments, the calcium carbonate comprises the calcite polymorph of calcium carbonate.

In some embodiments, the mineralized hemp fiber is flame retardant and/or has improved water dispersibility compared to a corresponding non-mineralized fiber. In some embodiments, the mineralized hemp fiber has one or more of a higher specific modulus, a higher tenacity, a higher strain at break, and a higher toughness compared to a corresponding non-mineralized hemp fiber.

In some embodiments, the presently disclosed subject matter provides a composition comprising the mineralized hemp fiber, wherein the mineralized hemp fiber is embedded in an organic or inorganic polymeric matrix.

In some embodiments, the presently disclosed subject matter provides a composition comprising the mineralized hemp fiber and further comprising cement, optionally Portland cement, another hydraulic cement, or a blended cement, further optionally wherein the composition further comprises silica and/or water. In some embodiments, the composition further comprises one or more of sodium alginate fiber, a glucarate salt; and microcrystalline cellulose. In some embodiments, the composition is for use as a construction material, optionally for use as a three-dimensional printing construction material.

In some embodiments, the presently disclosed subject matter provides a non-cementitious composition comprising the mineralized hemp fiber, optionally wherein the composition is for use in stucco or drywall applications.

In some embodiments, the presently disclosed subject matter provides a cementitious composition comprising the mineralized hemp fiber.

In some embodiments, the presently disclosed subject matter provides a method of preparing a green concrete, wherein the method comprises: (i) preparing a hemp fiber for mineralization; (ii) mineralizing the hemp fiber via sequential treatment with an aqueous solution comprising a calcium halide and an aqueous solution comprising an alkali metal carbonate, thereby providing a mineralized hemp fiber; (iii) preparing an aqueous dispersion of the mineralized hemp fiber, thereby providing a fiber slurry; (iv) preparing a dispersion of the fiber slurry and cement, thereby providing a cement mixture; and (v) molding or printing the cement mixture to provide a molded or printed green concrete object. In some embodiments, step (i) comprises carding and/or opening the hemp fiber. In some embodiments, step (i) comprises decorticating and/or degumming the hemp fiber. In some embodiments, the mineralizing of step (ii) comprises spraying the hemp fiber sequentially with the aqueous solution comprising calcium chloride and the aqueous solution comprising an alkali metal carbonate or dipping the hemp fiber sequentially in the aqueous solution comprising calcium chloride and the aqueous solution comprising an alkali metal carbonate.

It is an object of the presently disclosed subject matter to provide methods of mineralizing hemp fiber, as well as to the mineralized hemp fiber itself, compositions comprising the mineralized hemp fiber and related methods of preparing green concrete. This and other objects are achieved in whole or in part by the presently disclosed subject matter. Further, an object of the presently disclosed subject matter having been stated above, other objects and advantages of the presently disclosed subject matter will become apparent to those skilled in the art after a study of the following description and Figures.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a confocal micrograph image (black and white) of the cross-section of a bundle of mineralized long hemp fiber. The scale bars in the lower left corner represent 100 micrometers (μm).

FIG. 1B is a confocal micrograph image (black and white) of the cross-section of a bundle of mineralized short hemp fiber. The scale bars in the lower left corner represent 100 micrometers (μm).

FIG. 1C is a confocal micrograph image (brightfield) of the cross-section of a bundle of mineralized long hemp fiber that was mineralized using a sequential spraying method of the presently disclosed subject matter. The bundle was embedded in cork and the lighter, beige sections shown in the image show light reflecting off the cork. The scale bars in the lower left corner represent 100 micrometers (μm).

FIG. 1D is a confocal micrograph image (brightfield) of the cross-section of a bundle of mineralized short hemp fiber that was mineralized using a sequential spraying method of the presently disclosed subject matter. The bundle was embedded in cork and the lighter, beige sections shown in the image show light reflecting off the cork. The scale bars in the lower left corner represent 100 micrometers (μm).

FIG. 1E is a photographic image of a batch of non-mineralized “short” hemp fibers, used in the examples described herein, showing fiber length distribution within the batch. The average length of the short fibers is 26.0±0.01 millimeters (mm) and the linear density (in denier) is 22.76.

FIG. 1F is a photographic image of a batch of “long” hemp fibers, used in the examples described herein, showing fiber length distribution within the batch. The average length of the long fibers is 30.3±0.01 millimeters (mm) and the linear density (in denier) is 23.79.

FIG. 1G is a photographic image of carded hemp fiber from the drum carder.

FIG. 1H is a photographic image of the large and small rollers of the carding machine.

FIG. 1I is a graph showing the frequency (expressed as a percentage (%)) versus orientation angle (expressed as a range of degree) of hemp fibers that were carded for 10 turns using a manual drum carder.

FIG. 1J is a graph showing the frequency (expressed as a percentage (%)) versus orientation angle (expressed as a range of degree) of hemp fibers that were carded for 20 turns using a manual drum carder.

FIG. 1K is a graph showing the frequency (expressed as a percentage (%)) versus orientation angle (expressed as a range of degree) of hemp fibers that were carded for 40 turns using a manual drum carder.

FIG. 1L is a composite of micrograph images of short and long hemp fibers that were carded for ten turns (10T) and mineralized using 20 dipping method cycles (20DC) using either sodium carbonate (Na₂CO₃) or potassium carbonate (K₂CO₃) as the alkali metal carbonate. For comparison, images of control (unmineralized) fibers are also shown.

FIG. 1M is a series of scanning electron microscopy (SEM) micrographs at low (left) or high (right) resolution for (top) unmineralized hemp (hemp with 0 percent mineralization degree (0% MD)) and (bottom) short hemp fibers carded for 10 turns (10T) and mineralized via sequential dipping in aqueous solutions of calcium chloride and sodium carbonate for a total of 20 dipping cycles (20DC). The mineralized hemp had 45% MD. Scale bars at the bottom right of each image on the left represent 100 micrometers (μm) and those in the bottom right of each image on the right represent 20 μm.

FIG. 2A is a composite graph showing the x-ray diffraction (XRD) patterns (counts versus position (2 theta (0)) of short (S) and long (L) hemp fibers carded for 10 or 50 turns (10T or 50T). The turns were hand turns of a manual drum carder desktop machine. The samples were prepared from fiber batts that weighed 6.289 g of long or short fiber. The fibers were first opened manually to achieve better carding and then carded for 10 or 50 turns. The fibers were then mineralized using 10 or 20 cycles of the dipping method with sodium carbonate in the alkali metal carbonate solution. The top pattern is for long fibers carded for 10 turns and mineralized via 10 dipping cycles (L10turns_10cycles); the pattern second from the top is for long fibers carded for 50 turns and mineralized via 20 dipping cycles (L50turns_20cycle); the pattern third from the top is for short fibers carded for 10 turns and mineralized with 10 dipping cycles (S10turns_10cycles); and the pattern second from the bottom is for short fibers carded for 50 turns and mineralized with 20 dipping cycles (S50turns_20cycles). For comparison, the XRD pattern of CaCO₃ nanopowder (calcite polymorph) is shown at the bottom.

FIG. 2B is a composite graph showing the x-ray diffraction (XRD) patterns (counts versus position (2 theta (θ)) of short and long hemp fibers (SF or LF, respectively) carded for 10 or 50 turns (10T or 50T) and mineralized using 10 or 15 cycles (10DC or 15 DC) of the dipping method with potassium carbonate in the alkali metal carbonate solution. The top pattern is for long fibers carded for 10 turns and mineralized via 10 dipping cycles (LF 10T 10DC K); the pattern second from the top is for long fibers carded for 50 turns and mineralized via 15 dipping cycles (LF 50T 15DC K); the pattern third from the top is for short fibers carded for 10 turns and mineralized with 10 dipping cycles (SF 10T 10 DC K); and the pattern second from the bottom is for short fibers carded for 50 turns and mineralized with 15 dipping cycles (SF 50T 15DC K). For comparison, the XRD patterns of CaCO₃ nanopowder (calcite polymorph) is shown at the bottom.

FIG. 3 is a graph showing the degree of mineralization (expressed as a percentage (%)) for hemp fiber as a function of the number of spraying cycles used to mineralize the fiber (0, 5, 10, 15, or 20 spraying cycles). Data is provided for hemp fiber carded for 10 rotations (squares), 20 rotations (circles), 30 rotations (stars), 40 rotations (triangles) and 50 rotations (diamonds).

FIG. 4A is a pair of scanning electron microscopy (SEM) micrographs for (top) unmineralized hemp (hemp with 0 percent mineralization degree (0% MD)) and (bottom) hemp carded for 20 rotations and treated to 20 mineralization spraying cycles (Hemp-20R-20SC), having 109% MD. Scale bars at the bottom right of each image represent 100 micrometers (μm).

FIG. 4B is a pair of scanning electron microscopy (SEM) micrographs for the same hemp fibers shown in the micrographs in FIG. 4A, but at higher resolution. The top micrograph shows unmineralized hemp (hemp with 0 percent mineralization degree (0% MD)) and the bottom micrograph shows hemp carded for 20 rotations and treated to 20 mineralization spraying cycles (Hemp-20R-20SC), having 109% MD. Scale bars at the bottom right of each image represent 20 micrometers (μm).

FIG. 5 is a graph showing portions of the Fourier transform infrared spectroscopy (FTIR) spectra (absorbance in arbitrary units versus wavenumber in inverse centimeters (cm¹)) of unmineralized hemp (bottom spectra) and mineralized hemp (hemp carded for 20 rotations and treated to 20 mineralization spraying cycles (Hemp-20R-20SC)).

FIG. 6 is a series of x-ray photoelectron spectroscopy (XPS) spectra (bottom) and high-resolution scans (top) of unmineralized hemp (left) and mineralized hemp (right). The mineralized hemp was hemp that was mineralized by 20 mineralization spraying cycles after 20 carding rotations (Hemp-20R-20SC).

FIG. 7 is a graph showing the x-ray powder diffraction spectroscopy (XRD) patterns of unmineralized hemp (bottom, Hemp-Unmineralized) and hemp that had been mineralized with 20 spraying cycles after being carded for 20 rotations (middle-Hemp-20R-20SC). For comparison, the XRD pattern of calcium carbonate nano-powder is shown at the top (CaCO₃ Nano-powder).

FIG. 8 is a graph showing the comparison of mechanical strength between un-mineralized hemp fiber and mineralized hemp fiber (with mineralization degree (MD) ranging from 20 percent (%) to over 100%, see x-axis). Fiber tenacity (data shown as stars) is expressed in centinewton per decitex (cN/dtex) (see scale on the axis on the left) and fiber modulus (data shown as squares) is also expressed in cN/dtex (see scale on the axis on the right). Different hemp samples are indicated by letter: a, un-mineralized hemp; b, hemp carded for 20 turns and mineralized with 5 spraying cycles (Hemp-20R-5SC; c, hemp carded for 50 turns and mineralized with 5 spraying cycles (Hemp-50R-5SC); d, hemp carded for 20 turns and mineralized with 10 spraying cycles (Hemp-20R-10SC); e, hemp carded for 50 turns and mineralized with 10 spraying cycles (Hemp-50R-10SC); f, hemp carded for 20 turns and mineralized with 15 spraying cycles (Hemp-20R-15SC); g, hemp carded for 50 turns and mineralized with 15SC (Hemp-50R-15SC); h, hemp carded for 50 turns and mineralized with 20 spraying cycles (Hemp-50R-20SC); and i, hemp carded for 20 turns and mineralized with 20 spraying cycles (Hemp-20R-20SC).

FIG. 9A is a graph showing the stress-strain curves (centinewton per decitex (cN/dtex) versus percentage (%)) for un-mineralized and mineralized hemp fibers treated to wet or dry conditions. The mineralized hemp fibers are hemp fibers that were mineralized using 20 spraying cycles after being carded for 20 turns (Hemp-20R-20SC). Data for unmineralized hemp treated to dry conditions (Hemp-unmineralized-dry) is represented by the solid line; date for unmineralized hemp treated to wet conditions (Hemp-unmineralized-wet) is represented by the dotted line with larger, more widely spaced dots; data for Hemp-20R-20SC treated to dry conditions (Hemp-20R-20SC-dry) is represented by the dashed line; and data for Hemp-20R-20SC treated to wet conditions (Hemp-20R-20SC-wet) is represented by the dotted line with smaller, more closely spaced dots).

FIG. 9B is a graph showing the stress-strain curves (centinewton per decitex (cN/dtex) versus percentage (%)) for un-mineralized and mineralized hemp fibers treated with pore water or with pore water followed by dry conditions (pore water & dry). The mineralized hemp fibers are hemp fibers that were mineralized using 20 spraying cycles after being carded for 20 turns (Hemp-20R-20SC). Data for unmineralized hemp treated to pore water conditions (Hemp-unmineralized-pore water) is represented by the solid line; date for unmineralized hemp treated to pore water and dry conditions (Hemp-unmineralized-pore water & dry) is represented by the dotted and dashed line with two dots between dashes; data for Hemp-20R-20SC treated to pore water conditions (Hemp-20R-20SC-pore water) is represented by the dotted line; and data for Hemp-20R-20SC treated to pore water and dry conditions (Hemp-20R-20SC-pore water & dry) is represented by the dotted and dashed line with a single dot between dashes).

FIG. 10 is a series of scanning electron microscopy (SEM) micrographs for hemp fibers mineralized using 20 spraying cycles after being carded for 20 turns (Hemp-20R-20SC) treated to different conditions and/or under different resolution. The Hemp-20R-20SC has a mineralization degree (MD) of 109 percent (%). The top row are low (left) and high (right) resolution micrographs of Hemp-20R-20SC treated to dry conditions. The bottom row are low (left) and high (right) resolution micrographs of Hemp-20R-20SC treated to pore water conditions. The scale bars in the low resolution micrographs represent 100 micrometers (μm) while the scale bars in the high resolution micrographs represent 20 μm.

FIG. 11A is a series of photographic images showing flame retardancy testing of control (unmineralized) hemp (left) and hemp mineralized via the dipping cycles (right). The top row are images after 3 seconds after exposure to flame, while the bottom row are images 20 seconds after exposure to flame.

FIG. 11B is a photographic image of a hemp fiber batts mineralized via dipping cycles after flame retardancy testing.

FIG. 11C is a photographic image of a hemp fiber batt mineralized via spraying cycles after flame retardancy testing.

FIG. 12 is diagram with photographic images showing a process for preparing a “green” concrete wall according to the presently disclosed subject matter, including carding hemp staple fibers to open the fiber structure; mineralizing the carded fiber via sequential spraying or dipping of the fiber in an aqueous calcium halide solution and an aqueous alkali metal carbonate solution; preparing a slurry of the mineralized hemp fiber; preparing a cement admixture comprising the slurry; and preparing a molded part from the admixture.

FIG. 13A is a graph showing the sand particle size distribution (particle diameter in millimeters (mm) versus percent passing (%)) of sand used in exemplary hemp mortar compositions.

FIG. 13B is a graph showing the setting time (in minutes) of different mineralized hemp-containing mortars. The heavy dashed horizontal line represents the penetration depth (in millimeters (mm)) commonly used to determine initial set (or the time at which finishing operations can begin). The different hemp-containing mortars include one mortar containing hemp mineralized using the dipping protocol (referred to as “Hemp A”) at a dosage of 0.1% of the cement weight (0.1% Hemp A) and a mortar containing Hemp A at a dosage of 1% of the cement weight (1% Hemp A). As a comparison, the setting time for a non-hemp containing Portland limestone cement (Control) is also shown.

FIG. 14 is a graph showing the compressive strengths of cementitious mixtures containing mineralized hemp fibers after 7 days or 28 days of curing. The hemp-containing mixtures include one mixture containing hemp mineralized via the dipping protocol (referred to as “Hemp A”) at a dosage of 0.1% of the cement weight (0.1% Hemp A), one mixture containing hemp mineralized using the spraying protocol (referred to as “Hemp C”) at a dosage of 0.1% of the cement weight (0.1% Hemp C), and one mixture containing Hemp A at a dosage of 1% of the cement weight (1% Hemp A). As a comparison, the setting time for a non-hemp-containing Portland limestone cement (PLC) is also shown.

FIG. 15 is a graph showing the bulk electrical resistivity of cementitious mixtures containing hemp fibers after 2, 7 or 28 days of curing. The hemp-containing mixtures include a mixture containing hemp mineralized via the dipping protocol (referred to as “Hemp A”) at a dosage of 0.1% of the cement weight (0.1% Hemp A), one mixture containing mineralized hemp prepared using the spraying protocol (referred to as “Hemp C”) at a dosage of 0.1% of the cement weight (0.1% Hemp C), and a mixture containing Hemp A at a dosage of 1% of the cement weight (1% Hemp A). As a comparison, the setting time for a non-hemp-containing Portland limestone cement (PLC) is also shown.

FIG. 16 is a graph showing the flexural strength (measured in pounds per square inch (PSI)) of different cementitious mixtures: Portland limestone cement (PLC), a mixture containing hemp mineralized using the dipping protocol (i.e., “Hemp A”) at a dosage of 1% of the cement weight (1% Hemp A), and a mixture containing hemp at a dosage of 5% of the cement weight.

FIG. 17 is a graph showing the expansion of two mortar samples in water: (left) Portland limestone cement (PLC) and (right) a cementitious mixture containing hemp mineralized using the dipping protocol (i.e. “Hemp A”) at a dosage of 1% of the cement weight (1% Hemp A).

FIG. 18 is a graph showing the expansion of two mortar samples exposed to a sulfate solution: (left) Portland limestone cement (PLC), and a cementitious mixture containing hemp mineralized using the dipping protocol (i.e., “Hemp A”) at a dosage of 1% of the cement weight (1% Hemp A).

### DETAILED DESCRIPTION

The presently disclosed subject matter will now be described more fully. The presently disclosed subject matter can, however, be embodied in different forms and should not be construed as limited to the embodiments set forth herein below and in the accompanying Examples. Rather, these embodiments are provided so that this disclosure will be thorough and complete, and will fully convey the scope of the embodiments to those skilled in the art.

All technical and scientific terms used herein, unless otherwise defined below, are intended to have the same meaning as commonly understood by one of ordinary skill in the art. References to techniques employed herein are intended to refer to the techniques as commonly understood in the art, including variations on those techniques or substitutions of equivalent techniques that would be apparent to one of skill in the art.

In describing the presently disclosed subject matter, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the presently disclosed and claimed subject matter.

### I. Definitions

The terminology used herein is for the purpose of describing particular embodiments only and is not intended to be limiting of the presently disclosed subject matter.

While the following terms are believed to be well understood by one of ordinary skill in the art, the following definitions are set forth to facilitate explanation of the presently disclosed subject matter.

All technical and scientific terms used herein, unless otherwise defined below, are intended to have the same meaning as commonly understood by one of ordinary skill in the art. References to techniques employed herein are intended to refer to the techniques as commonly understood in the art, including variations on those techniques or substitutions of equivalent techniques that would be apparent to one of skill in the art. While the following terms are believed to be well understood by one of ordinary skill in the art, the following definitions are set forth to facilitate explanation of the presently disclosed subject matter.

In describing the presently disclosed subject matter, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the presently disclosed and claimed subject matter.

Following long-standing patent law convention, the terms “a”, “an”, and “the” refer to “one or more” when used in this application, including in the claims. For example, the phrase “a light source” refers to one or more light sources, including a plurality of the same type of light source. Similarly, the phrase “at least one”, when employed herein to refer to an entity, refers to, for example, 1, 2, 3, 4, 5, 6, 7, 8, 9, 10, 15, 20, 25, 30, 35, 40, 45, 50, 75, 100, or more of that entity, including but not limited to whole number values between 1 and 100 and greater than 100.

Unless otherwise indicated, all numbers expressing quantities of temperature, time, concentration, length, width, height, and so forth used in the specification and claims are to be understood as being modified in all instances by the term “about”. The term “about”, as used herein when referring to a measurable value such as an amount of mass, weight, time, volume, length, width, or temperature is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods and/or employ the disclosed subject matter. Accordingly, unless indicated to the contrary, the numerical parameters set forth in this specification and attached claims are approximations that can vary depending upon the desired properties sought to be obtained by the presently disclosed subject matter.

Numerical ranges recited herein by endpoints include all numbers and fractions subsumed within that range (e.g. 1 to 5 includes 1, 1.5, 2, 2.75, 3, 3.90, 4, 4.24, and 5). Similarly, numerical ranges recited herein by endpoints include subranges subsumed within that range (e.g. 1 to 5 includes 1-1.5, 1.5-2, 2-2.75, 2.75-3, 3-3.90, 3.90-4, 4-4.24, 4.24-5, 2-5, 3-5, 1-4, and 2-4).

As used herein, the term “and/or” when used in the context of a list of entities, refers to the entities being present singly or in combination. Thus, for example, the phrase “A, B, C, and/or D” includes A, B, C, and D individually, but also includes any and all combinations and subcombinations of A, B, C, and D.

The term “comprising”, which is synonymous with “including” “containing”, or “characterized by”, is inclusive or open-ended and does not exclude additional, unrecited elements and/or method steps. “Comprising” is a term of art that means that the named elements and/or steps are present, but that other elements and/or steps can be added and still fall within the scope of the relevant subject matter.

As used herein, the phrase “consisting essentially of” limits the scope of the related disclosure or claim to the specified materials and/or steps, plus those that do not materially affect the basic and novel characteristic(s) of the disclosed and/or claimed subject matter.

As used herein, the phrase “consisting of” excludes any element, step, or ingredient not specifically recited. It is noted that, when the phrase “consists of” appears in a clause of the body of a claim, rather than immediately following the preamble, it limits only the element set forth in that clause; other elements are not excluded from the claim as a whole.

With respect to the terms “comprising”, “consisting of”, and “consisting essentially of”, where one of these three terms is used herein, the presently disclosed and claimed subject matter can include the use of either of the other two terms.

As used herein, a “monomer” refers to a non-polymeric molecule that can undergo polymerization, thereby contributing constitutional units, i.e., an atom or group of atoms, to the essential structure of a macromolecule.

As used herein, a “macromolecule” refers to a molecule of high relative molecular mass, the structure of which comprises the multiple repetition of units derived from molecules of low relative molecular mass, e.g., monomers and/or oligomers.

An “oligomer” refers to a molecule of intermediate relative molecular mass, the structure of which comprises a small plurality (e.g., 2, 3, 4, 5, 6, 7, 8, 9, or 10) of repetitive units derived from molecules of lower relative molecular mass.

As used herein the terms “polymer”, “polymeric” and “polymeric matrix” refer to a substance comprising macromolecules. In some embodiments, the term “polymer” can include both oligomeric molecules and molecules with larger numbers (e.g., >10, >20, >50, >100) of repetitive units. In some embodiments, “polymer” refers to macromolecules with at least 10 repetitive units. A “copolymer” refers to a polymer derived from more than one species of monomer.

The term “thermoplastic” can refer to a polymer that softens and/or can be molded above a certain temperature, but which is solid below that temperature. Thermoplastic polymers include, but are not limited to, ethylene vinyl acetate copolymers (EVA), polyolefins (e.g., polyethylene, polypropylene (PP), polyamides, some polyesters (e.g., polybutylene terephthalate (PBT)), styrene block copolymers (SBCs), polycarbonates, silicone rubbers, fluoropolymers, thermoplastic elastomers, polypyrrole, polycaprolactone, polyoxymethylene (POM), and mixtures and/or combinations thereof.

In contrast, the term “thermosetting” refers to a polymer that sets permanently when polymerized (e.g., via cross-linking). Examples of thermosetting polymers include, but are not limited to, some polyesters, melamine, silicones, epoxys, polyurethanes, and urea formaldehyde.

The term “sacchaide” refers to a carbohydrate monomer, oligomer or larger polymer. Thus, a saccharide can be a compound that includes one or more cyclized monomer unit based upon an open chain form of a compound having the chemical structure H(CHOH)ₙC(═O)(CHOH)ₘH, wherein the sum of n+m is an integer between 2 and 8. Thus, the monomer units can include trioses, tetroses, pentoses, hexoses, heptoses, nonoses, and mixtures thereof. In some embodiments, each cyclized monomer unit is based on a compound having a chemical structure wherein n+m is 4 or 5. Thus, saccharides can include monosaccharides including, but not limited to, aldohexoses, aldopentoses, ketohexoses, and ketopentoses such as arabinose, lyxose, ribose, xylose, ribulose, xylulose, allose, altrose, galactose, glucose, gulose, idose, mannose, talose, fructose, psicose, sorbose, and tagatose, and to hetero- and homopolymers thereof. Saccharides can also include disaccharides including, but not limited to sucrose, maltose, lactose, trehalose, and cellobiose, as well as hetero- and homopolymers thereof.

The term “lignocellulosic” refers to a composition comprising both lignin and cellulose. In some embodiments, lignocellulosic material can comprise hemicellulose, a polysaccharide which can comprise saccharide monomers other than glucose. Typically, lignocellulosic materials comprise between about 30-45 weight % cellulose, about 20-35 weight % hemicellulose; and about 3-35 weight % lignin.

“Lignin” is a polyphenolic material comprised of phenyl propane units linked by ether and carbon-carbon bonds. Lignins can be highly branched and can also be crosslinked. Lignins can have significant structural variation that depends, at least in part, on the plant source involved.

The term “cellulose” refers to a polysaccharide of β-glucose (i.e., β-1,4-glucan) comprising β-(1-4) glycosidic bonds. The term “cellulosic” refers to a composition comprising cellulose.

The term “hemicellulose” can refer polysaccharides comprising mainly sugars or combinations of sugars other than glucose (e.g., xylose). Thus, xylan (polymerized xylose) and mannan (polymerized mannose) are exemplary hemicelluloses. Hemicellulose can be highly branched. Hemicellulose can be chemically bonded to lignin and can further be randomly acetylated, which can reduce enzymatic hydrolysis of the glycosidic bonds in hemicellulose.

The terms “glycosidic bond” and “glycosidic linkage” refer to a linkage between the hemiacetal group of one saccharide unit and the hydroxyl group of another saccharide unit.

The term “cement” as used herein refers to an inorganic binder material, typically based on lime or calcium silicate. When mixed with water, cement can be used as a mortar. When mixed with water, sand and gravel, it can form concrete. Cements can be classified as hydraulic cements (e.g., Rosendale cement, Portland cement, etc.) or non-hydraulic.

The term “alkali metal carbonate” as used herein refers to a compound comprising a carbonate (CO₃) of an alkali metal ion (i.e., lithium (Li), sodium (Na), potassium (K), rubidium (Rb), cesium (Cs), or francium (Fr)) or a hydrate thereof. In some embodiments, the alkali metal carbonate has a formula M₂CO₃, where M is an alkali metal ion.

The term “calcium halide” as used herein refers to a compound with the formula (CaX₂), wherein X is a halide (i.e., fluoride (F), chloride (CI), bromide (Br), or iodide (I)).

As used herein, the term “fiber,” refers to an elongated strand of material in which the length to width ratio is greater than about 10, greater than about 25, greater than about 50 or greater than about 100. A fiber typically has a round, or substantially round, cross section. Other cross-sectional shapes for the fiber include, but are not limited to, oval, square, triangular, rectangular, star-shaped, trilobal, pentalobal, octalobal, and flat (i.e., “ribbon” like) shape. The fiber can have any desired diameter, for example, thicker fibers (or “rods) can be chopped or pelletized, while thinner fibers can be used to prepare yarns or fabrics. In some embodiments, the fiber has a diameter of less than about 250 microns, less than about 200 microns, less than about 150 microns, less than about 100 microns, less than about 75 microns, less than about 50 microns, less than about 25 microns, or less than about 10 microns. In some embodiments, the fiber has a thickness of about 1 micron to about 250 microns. In some embodiments, the fiber has a thickness greater than about 250 microns. For example, thicker fibers or rods that can be chopped to provide pellets can have a thickness of a few hundred microns (e.g., about 300 microns, about 400 microns, about 500 microns, or about 750 microns) to a few millimeters (mm) (e.g., about 5 mm, about 10 mm, or about 25 mm). In some embodiments, the thicker fibers or rods can have a diameter of about 1 mm to about 5 mm (e.g., 1 mm, 1.5 mm, 2 mm, 2.5 mm, 3 mm, 3.5 mm, 4 mm, 4.5 mm, or about 5 mm). In some embodiments, the thicker fibers or rods can be chopped into pellets having a length of about 1 mm to about 5 mm (e.g., 1 mm, 1.5 mm, 2 mm, 2.5 mm, 3 mm, 3.5 mm, 4 mm, 4.5 mm, or about 5 mm).

### II. Mineralized Hemp Fibers. Related Compositions and Methods

The development of organic-inorganic hybrid fibers has been a topic of interest in recent years due to their exceptional strength and toughness, making them ideal for medical and biotechnological applications where biocompatibility is crucial. However, the methods used for their fabrication, such as microfluid devices and expensive polymers like calcium phosphate oligomer (CPOc) and regenerated silk fibroin, is generally not efficient for large scaling due to the high costs associated with the advanced technology and materials.¹

In particular, the use of natural fibers as the organic component in the organic-inorganic hybrid fibers is of interest due to the cost-effectiveness,^{10,11} biodegradability,^{12,13} renewability,^{14,15} accessibility,^{16,17} and lower density¹⁸ of natural fibers as compared to synthetic fibers like carbon, glass, and aramid fiber.¹⁹⁻²¹ Bambach M. R.²² conducted research that compares natural fibers like flax, jute, and hemp with synthetic fibers like glass and carbon when making strong materials. However, although natural fibers are renowned for their eco-friendliness and sustainability, their tendency to degrade in situations requiring long-term durability, absorbing moisture, and exhibiting variability can pose challenges in maintaining consistent material quality and performance.²³⁻²⁶ As such, it is useful to consider the biochemical behaviors of these fibers when seeking to modify their surface qualities.

According to one aspect of the presently disclosed subject matter, natural fiber is utilized in combination with non-expensive, non-toxic chemicals, to provide a method to produce an organic-inorganic hybrid fiber. The method can be optimized for scalable production, making it a potentially cost-effective and environmentally friendly alternative for the production of organic-inorganic hybrid fibers. For example, in some embodiments, the presently disclosed subject matter provides a mineralization method that deposits CaCO₃ crystals onto a surface of a fiber (e.g., a natural fiber, such as hemp) through a double displacement reaction, transforming it into a bioinorganic composite with enhanced mechanical properties. This promising development has potential applications where high performance is required, such as in textile material and strengthening composites.

In some embodiments, the presently disclosed subject matter relates to mineralized hemp fiber (e.g., mineralized hemp stable fibers), to methods of preparing mineralized hemp fiber, to compositions comprising mineralized hemp fiber (including both cementitious and non-cementitious compositions or admixtures comprising the mineralized hemp fiber), and to the use of the mineralized hemp fiber and the compositions thereof, e.g., as a construction material.

### II.A. Methods of Mineralizing Hemp Fiber

In some embodiments, the presently disclosed subject matter provides a method of mineralizing a fiber. In some embodiments, the fiber is a natural fiber. In some embodiments, the fiber is a hemp fiber. In some embodiments, the fibers (e.g., the hemp fibers) are mineralized with calcium carbonate by exposing the fibers to consecutive/sequential treatments with an aqueous alkali metal carbonate (e.g., sodium carbonate, potassium carbonate, etc.) solution and an aqueous calcium halide (e.g., calcium chloride) solution.

Thus, in some embodiments, the presently disclosed subject matter provides a method of mineralizing a hemp fiber. In some embodiments, the method comprises (a) providing a hemp fiber for mineralization; and (b) sequentially treating the hemp fiber with two aqueous solutions, wherein one of the two aqueous solutions (e.g., a “first” aqueous solution) comprises a calcium halide and wherein another of the two aqueous solutions (e.g., a “second” aqueous solution) comprises an alkali metal carbonate, thereby providing a hemp fiber mineralized with calcium carbonate (e.g., a hemp fiber having a surface covered or partially covered with a coating comprising deposited calcium carbonate).

Providing a hemp fiber for mineralization can comprise providing any suitable hemp fiber to be mineralized. In some embodiments, the hemp fibers to be mineralized are hemp staple fibers. In some embodiments, the hemp fibers have lengths of about 10 mm or more. In some embodiments, the hemp fibers have lengths of about 10 mm to about 125 mm. In some embodiments, the hemp fibers have lengths of about 10 mm to about 100 mm. In some embodiments, the hemp fibers are mineralized after decortication, a process that separates the fibers (e.g., separates the bast (outer stalk fibers) and hurd (core) fibers) via a mechanical process. Decortication can also affect the diameter and length of the hemp fibers. The hemp fibers to be mineralized can also be provided with or without degumming (which can provide “cottonized” hemp).

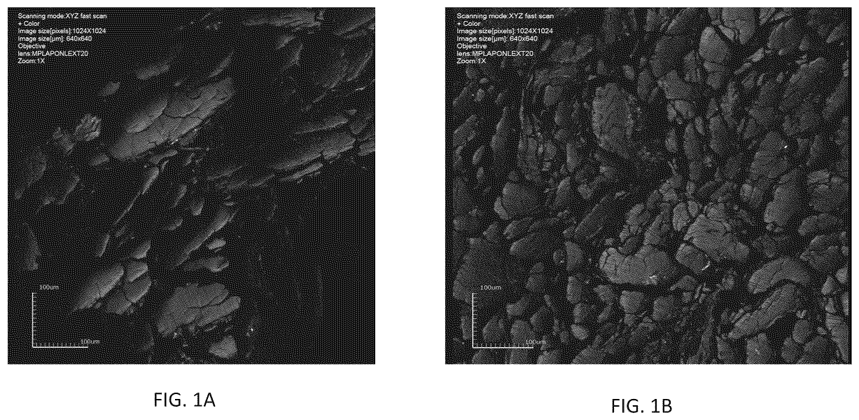

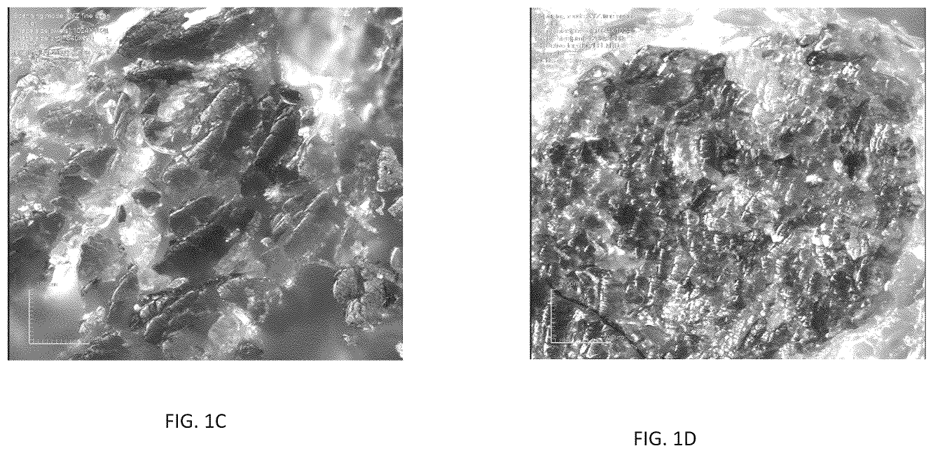

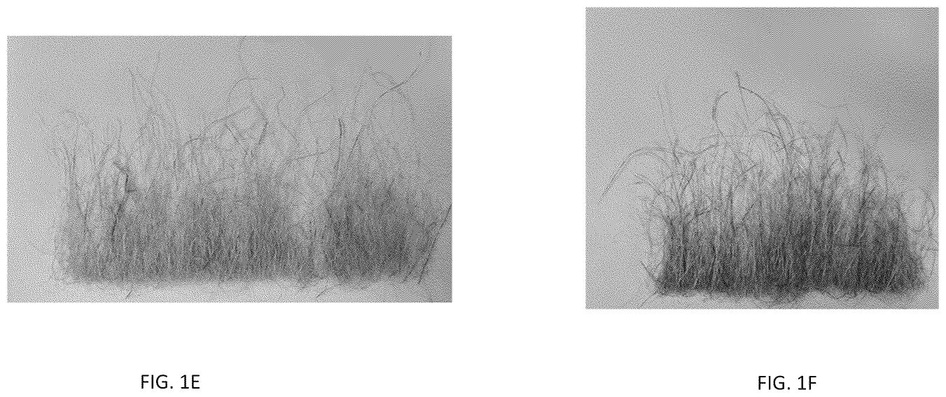

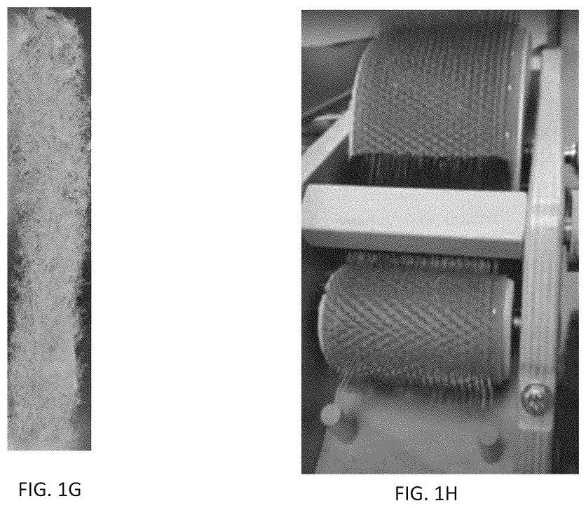

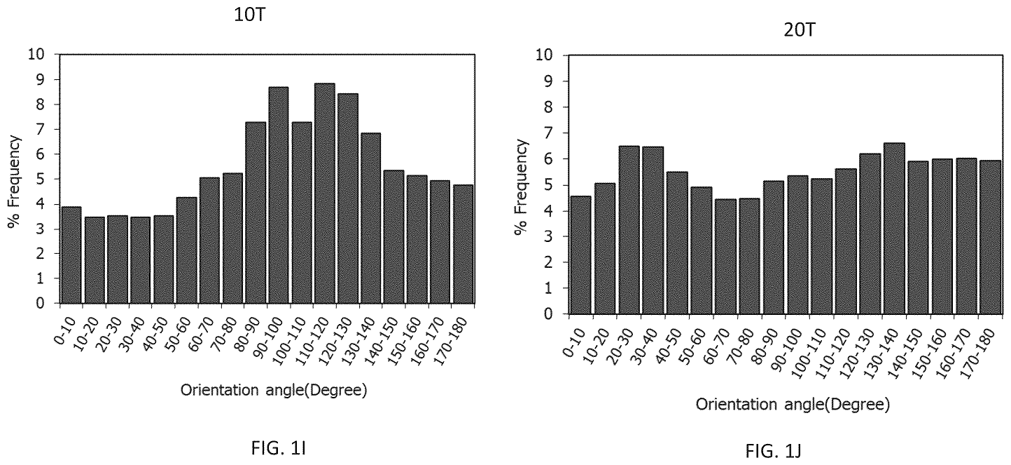

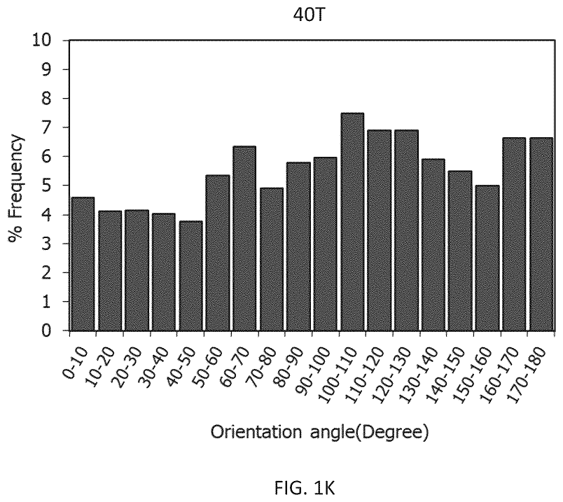

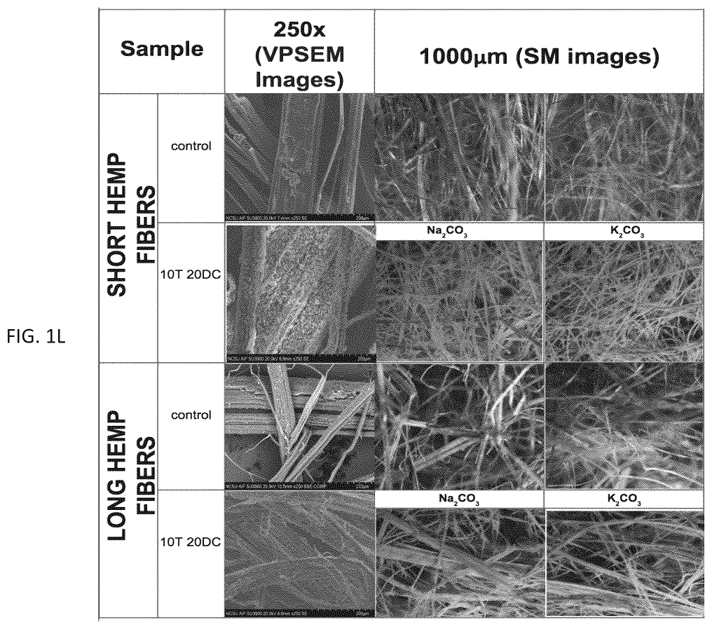

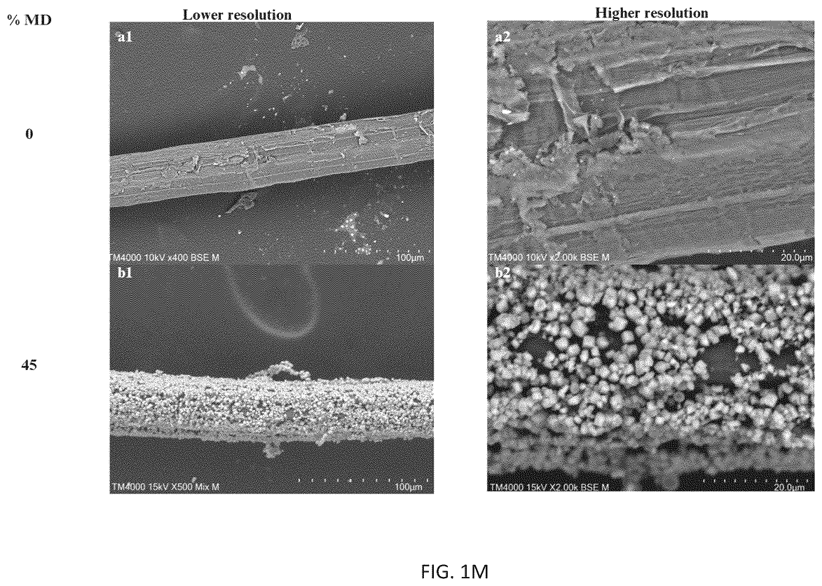

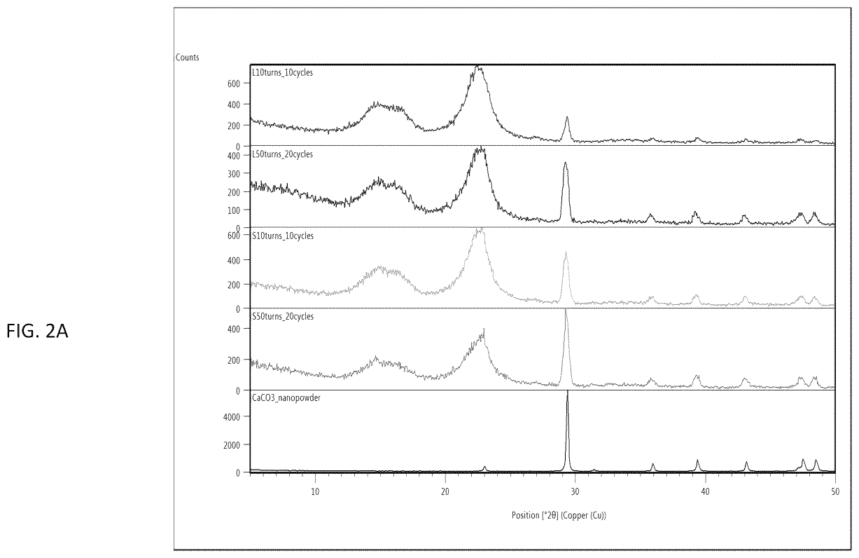

Hemp fibers that can be mineralized as described herein can be obtained from commercial sources, such as, but not limited to, BastCore (Montgomery, Alabama, United States of America) and Hemp Ventures, Inc. (Omaha, Nebraska, United States of America). In examples herein below, exemplary batches of hemp fibers are described that are referred to as “long” and “short.” The fiber length distributions of these exemplary fiber batches were determined using a Peyer AL-101 and FL-101 with Winwool Software according to ASTM D5331-Fiber Length and Length Distribution of Cotton and Man-Made Staple fibers. The “long” hemp fibers have an average length (by number) of about 30.3 mm (min %<10.0 mm: 7.6%; L 95.0%: 8.6 mm; Max %<50.0 mm: 85.3%; L 1.0%: 79.4 mm). Short hemp fibers can have an average length (by number) of about 26.0 mm (Min %, 10.0 mm: 4.4%; L 95.0%: 10.2 mm; Max %<50.0 mm: 95.2; L 1.0%: 58.8 mm). See FIGS. 1E and 1F.

In some embodiments, prior to mineralization, the hemp fibers are opened, carded, or both opened and carded. Natural fibers, such as hemp fibers, are often transported and stored in the form of highly compressed bales. In baled form, the fibers can be matted or entangled. The reduction of the bulk density of the bales into progressively smaller tufts of fiber is referred to as “opening” or “fiber opening”. The higher the degree of opening, the greater the volume occupied by a given mass of fibers. “Carding” can refer to processes of separating individual fibers, removing impurities, and/or causing fibers to lie parallel to one another.

Opening and/or carding can be performed by hand or mechanized. Carding the fibers (e.g., to provide non-woven mats or batts of the fibers) prior to mineralization can improve the extent of mineralization/coverage of the individual fibers. As an alternative or addition to carding, the fibers can be treated with an opener, e.g., a bale opener. Methods, devices, and machines for opening and carding fibers are known in the art. Typically, a device or machine for opening fibers (e.g., a fiber bale) has fewer teeth than a device or machine for carding fibers and can be useful for more brittle fibers. Devices or machines for opening or carding include, for example, the mini carded machine from MESDAN (Puegnago del Garda, Italy) for carding or opening long fibers and the Trützschler High-Speed Nonwoven Card EWK 413 (Trützschler Group SE, Mönchengladbach, Germany) for shorter fibers.

In some embodiments, the aqueous solution comprising the alkali metal carbonate comprises one or more of sodium carbonate (Na₂O₃), potassium carbonate (K₂CO₃), or cesium carbonate (Cs₂CO₃). In some embodiments, the alkali metal carbonate solution comprises Na₂CO₃. In some embodiments, the aqueous solution comprising an alkali metal carbonate has an alkali metal carbonate concentration of about 20 mM to about 500 mM (e.g., about 20 mM, about 40 mM, about 60 mM, about 80 mM, about 100 mM, about 120 mM, about 140 mM, about 160 mM, about 180 mM, about 200 mM, about 220 mM, about 240 mM, about 260 mM, about 280 mM, about 300 mM, about 320 mM, about 340 mM, about 360 mM, about 380 mM, about 400 mM, about 420 mM, about 440 mM, about 460 mM, about 480 mM, or about 500 mM). In some embodiments, the aqueous solution comprising alkali metal carbonate has an alkali metal carbonate concentration of about 140 mM.

In some embodiments, the aqueous solution comprising the calcium halide comprises calcium chloride (CaCl₂). In some embodiments, the aqueous solution comprising a calcium halide has a calcium halide concentration of about 20 mM to about 500 mM (e.g., about 20 mM, about 40 mM, about 60 mM, about 80 mM, about 100 mM, about 120 mM, about 140 mM, about 160 mM, about 180 mM, about 200 mM, about 220 mM, about 240 mM, about 260 mM, about 280 mM, about 300 mM, about 320 mM, about 340 mM, about 360 mM, about 380 mM, about 400 mM, about 420 mM, about 440 mM, about 460 mM, about 480 mM, or about 500 mM). In some embodiments, the aqueous solution comprising a calcium halide has a calcium halide concentration of about 140 mM.

In some embodiments, the concentration of alkali metal carbonate in the aqueous solution comprising alkali metal carbonate is about 1 to about 2 times the concentration of calcium halide in the aqueous solution comprising calcium halide. In some embodiments, the concentration of alkali metal carbonate in the aqueous solution comprising alkali metal carbonate is about the same as the concentration of calcium halide in the aqueous solution of calcium halide.

The consecutive treatments with the aqueous solutions of alkali metal carbonate and calcium halide can include, for example, sequentially spraying the aqueous solutions on hemp fibers or sequentially dipping the hemp fibers in the aqueous solutions. In some embodiments, spraying conditions for the consecutive treatments can provide mineralized hemp fibers that exhibit higher degrees of mineralization than hemp fibers mineralized through repeated cycles of dipping the fiber in the aqueous solutions. In some embodiments, dipping can be performed by (1) placing fibers in a porous bag (e.g., a “sachet”) or a sieve (e.g., a metal or plastic porous sieve) and (2) immersing the fibers in a bath or vat of an aqueous solution or in a laundering unit where the different solutions and rinse water could be dispensed sequentially. Spraying can be performed with any suitable spraying device, e.g., batts of fibers can be sprayed with a pneumatic sprayer, an electrostatic sprayer, an air sprayer or an airless sprayer.

In some embodiments, sequentially treating the hemp fiber with the two aqueous solutions comprises sequentially dipping the hemp fiber into the two aqueous solutions. In some embodiments, sequentially treating the hemp fiber with the two aqueous solutions comprises: (b1) dipping the hemp fiber into the aqueous solution comprising the calcium halide (e.g., about 140 mM calcium halide) for a period of time, removing the hemp fiber from the solution, and draining the hemp fiber for a period of time; (b2) rinsing the hemp fiber with water for a period of time and draining the hemp fiber for a further period of time; (b3) dipping the hemp fiber into the aqueous solution comprising the alkali metal carbonate (e.g., about 140 mM alkali metal carbonate) for a period of time, removing the hemp fiber from the solution and draining the hemp fiber for a period of time; (b4) rinsing the hemp fiber with water for a period of time and draining the hemp fiber for a further period of time; and (b5) drying the hemp fiber for a period of time. Steps (b1)-(b4) can be repeated one or more times, e.g., to increase the degree of mineralization of the mineralized fiber. For example, the steps can be repeated 1 to about 50 times (1, 2, 3, 4, 5, 10, 15, 20, 25, 30, 35, 40, 45, or 50 times). In some embodiments, the period of time the hemp fiber is dipped into a solution comprising calcium halide and/or alkali metal carbonate is about 5 seconds to about 5 minutes. In some embodiments, the period of time the fiber is dipped in step (b1) and/or (b3) is about 15 seconds to about 60 seconds (e.g., about 15, 20, 25, 30, 35, 40, 45, 50, 55, or about 60 seconds). In some embodiments, the period of time the hemp fiber is dipped in step (b1) and/or (b3) is about 40 seconds to about 60 seconds. In some embodiments, the period of time the hemp fiber is drained in any one or more of steps (b1)-(b4) is about 10 seconds to about 5 minutes (e.g., about 15 seconds to about 60 seconds). In some embodiments, the draining time is about 40 seconds to about 60 seconds. In some embodiments, the rinsing is performed by dipping the hemp fiber into a water bath or vat comprising water. In some embodiments, the rinsing is performed by directing a stream of water over the hemp fiber. In some embodiments, the rinsing of step (b2) and/or (b4) is performed for a period of time of about 5 seconds to about 5 minutes. In some embodiments, the period of time the fiber is rinsed in step (b2) and/or (b4) is about 15 seconds to about 60 seconds (e.g., about 15, 20, 25, 30, 35, 40, 45, 50, 55, or about 60 seconds). In some embodiments, the period of time the hemp fiber is rinsed in step (b2) and/or (b4) is about 40 seconds. In some embodiments, the drying of step (b5) is performed at room temperature. In some embodiments, the drying of step (b5) is performed for a period of time of at least about 2 hours, at least about 4 hours, at least about 6 hours, at least about 8 hours, at least about 10 hours, at least about 12 hours, at least about 18 hours, or at least about 24 hours. Drying can also be performed, if desired in a convection oven, via infrared heating, or by using fans to remove excess moisture at room temperature (e.g., 20° C. to about 25° C.).

In some embodiments, sequentially treating the hemp fiber with the two aqueous solutions comprises sequentially spraying the hemp fiber with the two aqueous solutions. In some embodiments, sequentially treating the hemp fiber with the two aqueous solutions comprises: (b1) spraying the hemp fiber with the aqueous solution comprising the calcium halide (e.g., an aqueous solution comprising 140 mM CaCl₂), for a first period of time; (b2) waiting for a second period of time; (b3) spraying the hemp fiber with the aqueous solution comprising the alkali metal carbonate (e.g., an aqueous solution comprising about 140 mM alkali metal carbonate) for a third period of time; (b4) waiting for a fourth period of time; and (b5) drying the hemp fiber for a fifth period of time. In some embodiments, the hemp fiber is positioned on a screen (e.g., a vertically positioned mesh screen) for steps (b1)-(b4) to allow the solutions to drain off the hemp fiber, for example, during the second and fourth periods of time. In some embodiments, the first and/or third period of time are about 2 seconds to about 60 seconds (e.g., about 2, 4, 6, 8, 10, 15, 20, 25, 30, 35, 40, 45, 50, 55, or about 60 seconds). In some embodiments, the first and/or third period of time are about 2 seconds. In some embodiments, the first and/or third period of time are about 20 seconds. For treating larger amounts of fiber (e.g., 500 g or more), the thickness of the fiber layer on the screen can be maintained between about 0.5 inches (1.27 cm) and about 1 inch (2.54 cm) and the first and/or third period of time can be about 30 seconds to about 5 minutes. In some embodiments, the second and/or fourth period of time are about 5 seconds to about 120 seconds. In some embodiments, the second and/or fourth period of time are about 20 seconds or about 30 seconds. In some embodiments, the drying is performed at room temperature. In some embodiments, the fifth period of time is at least about 2 hours, at least about 4 hours, at least about 6 hours, at least about 8 hours, at least about 10 hours, at least about 12 hours, at least about 18 hours, or at least about 24 hours. In some embodiments, the fifth period of time is about 8 hours.

In some embodiments, the method further comprises heat treating (e.g., calcining) the mineralized hemp fiber. In some embodiments, the heat treating/calcining comprises heating the mineralized hemp fiber to a temperature and for a period of time sufficient to transform at least a portion of the calcium carbonate to calcium oxide and to transform at least a portion of the hemp fiber to biochar. In some embodiments, the heat treating/calcining comprises heating the mineralized hemp fiber to a temperature of about 600° C. to about 1000° C. (e.g., in a furnace, calciner, or kiln)

### II.B Mineralized Hemp Fiber

The presently disclosed mineralization processes provide a hemp fiber coated with calcium carbonate, but where the cellulosic structure of the coated hemp fiber is still present. Mineralization can render the hemp fibers more water dispersible than non-mineralized hemp fiber. For example, the mineralized hemp fibers can be more hydrophobic than non-mineralized hemp fibers, which can improve their water dispersibility. The increased hydrophobicity can also improve the flow of admixtures comprising the mineralized fibers through nozzles in three-dimensional (3-D) printing applications. Thus, mineralization can improve the compatibility of the hemp fibers with cement mixtures and other aqueous mixtures. In particular, the mineralization process provides a calcium carbonate coating on the hemp fibers where the calcium carbonate is present or mostly present in a calcite form, which has good stability and compatibility with cement. The calcium carbonate coating can also improve compatibility of the fibers with concrete upon drying. Moreover, mineralization can improve the strength of the hemp fibers compared to non-mineralized wet hemp fibers, with higher degrees of mineralization resulting in relatively higher levels of improvement in strength properties (e.g., higher tenacity, improved modulus, etc.). In addition, mineralization, particularly with the calcite polymorph of calcium carbonate, can render the hemp fibers flame retardant.

Accordingly, in some embodiments, the presently disclosed subject matter provides a mineralized hemp fiber. In some embodiments, the mineralized hemp fiber comprises a hemp fiber (e.g., a cellulosic hemp fiber) further comprising a coating (covering all or a portion of the outer surface of the hemp fiber) comprising or consisting of calcium carbonate. For instance, the coating can comprise calcium carbonate particles deposited on the surface of the hemp fiber. In some embodiments, the calcium carbonate comprises or consists of calcium carbonate in a calcite polymorph. In some embodiments, the calcium carbonate further comprises the vaterite and/or aragonite polymorph of calcium carbonate. In some embodiments, the calcium carbonate comprises the vaterite and calcite polymorph wherein at least 51% of the calcium carbonate is present as the calcite polymorph. In some embodiments, the calcium carbonate comprises about 55% to 100% calcite (e.g., 55%, 60%, 65%, 70%, 75%, 80%, 85%, 90%, 95%, 96%, 97%, 98%, 99%, or 100% calcite).

In some embodiments, the mineralized hemp fiber has a mineralization degree of about 1% to about 200%. For instance, in some embodiments, the mineralized hemp fiber has a mineralization degree (% MD) of about 5%, 10%, 20%, 30%, 40%, 50%, 60%, 70%, 80%, 90%, 100%, 110%, 120%, 130%, 140%, 150%, 160%, 170%, 180%, 190%, or 200%. In some embodiments, the % MD is about 40% to about 170%.

In some embodiments, the mineralized hemp fiber is more flame retardant and/or has improved water dispersibility compared to a corresponding non-mineralized hemp fiber (e.g., a unmineralized hemp fiber of the same length and/or diameter). In some embodiments, the mineralized hemp fiber has one or more of a higher specific modulus, a higher tenacity, a higher strain at break, and a higher toughness compared to a corresponding non-mineralized hemp fiber.

In some embodiments, the mineralized hemp fiber can be provided as yarns or rope or as woven or non-woven mats or fabrics.

In some embodiments, the presently disclosed subject matter provides a heat-treated mineralized hemp fiber of the presently disclosed subject matter. In some embodiments, the heat-treated mineralized hemp fiber is a mineralized hemp fiber that has been heated to a temperature of about 600° C. to about 1000° C. (e.g., in a furnace, calciner, or kiln) for a period of time sufficient to transform at least a portion of the calcium carbonate to calcium oxide and to transform at least a portion of the hemp fiber to biochar. Thus, in some embodiments, the mineralized hemp fiber is a calcined mineralized hemp fiber and the presently disclosed subject matter provides a fiber comprising a core comprising biochar and a coating over at least a portion of the surface of the core comprising calcium oxide.

### II.C. Mineralized Hemp Fiber-Containing Compositions

In some embodiments, the presently disclosed subject matter provides a composition comprising a mineralized hemp fiber as described herein. In some embodiments, the mineralized hemp fiber is disposed in a liquid (i.e., a liquid solution or suspension). The compositions can be cementitious or non-cementitious. In some embodiments, the mineralized hemp fiber is embedded in a solid, such as an organic or inorganic polymeric matrix. Thus, for example, the composition can be a polymeric composite comprising the mineralized hemp fiber. The mineralized hemp fiber can be the only fiber reinforcement in the composite (e.g., taking the place of fiberglass or carbon fiber in a composite material) or be used to replace some or all of another fiber (e.g., fiberglass) in a composite material. Accordingly, the mineralized fiber can be used as a fiberglass alternative.

In some embodiments, the composition comprises a cement (e.g., a Portland cement, other hydraulic cements, a blended cement, a cement sold under the tradename Quikrete® (Quikrete International, Inc., Atlanta, Georgia, United States of America), a lime-based cement, etc.). In some embodiments, the cement is a cement sold under the tradename ECOCEM® PLC (Ecocem Materials Ltd., Dublin, Ireland) by Heidelburg Materials (Heidelburg, Germany); High Early Cement, Fast Setting cement or Portland cement sold by Quikrete (Atlanta, Georgia, United States of America), or Portland cement or Portland Limestone cement sold by Cemex USA (Houston, Texas, United States of America). In some embodiments, the composition can further include water. In some embodiments, the composition can further comprise silica and/or water. In some embodiments, the composition can further include aggregate, e.g., sand and/or gravel. The mineralized fibers can be mixed with water to provide a fiber dispersion prior to addition to a mixture comprising cement or added directly to an admixture comprising cement and water (and optionally sand and aggregate). In some embodiments, the composition can further comprise one or more additional components, e.g., sodium alginate (e.g., a sodium alginate fiber), a salt (e.g., a glucarate salt), and/or cellulose particles (e.g., microcrystalline cellulose). In some embodiments, the composition can comprise about 0.5% to about 2% mineralized hemp fibers by weight of the total dry/solid components of the composition (e.g., about 0.5%, about 0.75%, about 1.0%, about 1.25%, about 1.5%, about 1.75%, or about 2% by weight of the total dry/solid components). In some embodiments, the composition can include a higher or lower % of mineralized hemp fiber. For example, in some embodiments, the composition comprises up to about 50% hemp fiber (comprising or consisting of mineralized hemp fiber) by weight of the total dry/solid components. In some embodiments, the composition comprises about 5% to about 50% hemp fiber (e.g., about 5%, about 10%, about 15%, about 20%, about 25%, about 30%, about 40%, about 45%, or about 50% hemp fiber comprising or consisting of mineralized hemp fiber).

The presently disclosed compositions comprising mineralized hemp and cement can be used, for example, as construction materials (i.e., materials to build houses or other buildings, roadways, retaining walls, bridges, etc.). In some embodiments, the composition comprising the mineralized hemp fiber and cement can be used to prepare a concrete blocks, bricks or other concrete objects. While these objects can be pre-cast or molded, mixtures of the mineralized hemp and cement can also be used directly at a job site to prepare concrete on an as-needed basis. In some embodiments, the composition can be used as a three-dimensional printing “ink” to prepare a construction material.

Accordingly, in some embodiments, the mineralized hemp fiber can be used to prepare a more sustainable/“green” concrete or other construction/building material. Cementitious admixtures comprising the mineralized hemp fiber can be used in numerous applications, such as, but not limited to, pre-cast wall segments, 3-D printing, marine or aquatic preservation or construction, river and bank retention, herd and livestock gorges, or as specialized cement additives for oil and gas drilling. In some embodiments, the inclusion of mineralized hemp fibers in a concrete admixture can accelerate the cure rate of the admixture and/or increase its slump rate (i.e., the consistency of the uncured admixture). In some embodiments, the inclusion of the mineralized hemp fibers can decrease the carbon dioxide emissions associated with concrete production, e.g., by replacing conventional concrete components and reducing the carbon dioxide emissions from cement plants.

In some embodiments, the presently disclosed subject matter provides a method of preparing a green concrete, wherein the method comprises: (i) preparing a hemp fiber for mineralization; (ii) mineralizing the hemp fiber via sequential treatment with an aqueous solution comprising a calcium halide and an aqueous solution comprising an alkali metal carbonate, thereby providing a mineralized hemp fiber; (iii) preparing an aqueous dispersion of the mineralized hemp fiber, thereby providing a fiber slurry; (iv) preparing a dispersion of the fiber slurry and cement, thereby providing a cement mixture; and (v) molding or printing the cement mixture to provide a molded or printed green concrete object. The step (i) can comprise one or more of decorticating, degumming, opening, and carding. In some embodiments, the mineralizing of step (ii) comprises spraying the hemp fiber sequentially with the aqueous solution comprising calcium chloride and the aqueous solution comprising an alkali metal carbonate or dipping the hemp fiber sequentially in the aqueous solution comprising calcium chloride and the aqueous solution comprising an alkali metal carbonate. In some embodiments, the fiber slurry or cement mixture can further comprise one or more additives as described elsewhere herein, e.g., sodium alginate, a glucarate, cellulose particles.

Non-cementitious admixtures comprising the mineralized hemp fiber can also be prepared. For example, the mineralized hemp fibers can be used as fillers in fiber-reinforced composites (e.g., with thermosetting polymers). In some embodiments, the mineralized hemp fibers can be mixed with a hydrated lime binder to form a type of “hempcrete”. Exemplary applications for non-cementitious admixtures of the mineralized fibers also include use as non-structural insulation, stucco, plaster, and drywall. In some embodiments, non-cementitious admixtures can be prepared including mineralized hemp fibers and one or more of: (a) lime; (b) hemp powder (i.e., micronized hurd powder with an average particle size of less than 500 μm); (c) micronized hemp hurd (as a plant-based aggregate of a diameter of about ⅛ inch (about 3175 μm) to about % inch (about 19,050 μm); and (d) recycled concrete aggregates. In some embodiments, lignin can be included in a non-cementitious admixture) with the mineralized hemp fibers. In some embodiments, the composition can comprise about 0.5% to about 2% mineralized hemp fibers by weight of the total dry/solid components of the composition (e.g., about 0.5%, about 0.75%, about 1.0%, about 1.25%, about 1.5%, about 1.75%, or about 2% by weight of the total dry/solid components). In some embodiments, the composition can include a higher or lower % of mineralized hemp fiber.

In some embodiments, an additive can be included in admixtures of the mineralized hemp fibers, e.g., alginate, a glucarate salt, or microcrystalline cellulose. In some embodiments, the additive is an additive that can provide self-healing properties. Exemplary materials that can provide self-healing include, but are not limited to alginate fibers and hydrogels, starch, polyvinyl alcohol (PVA), and polyelectrolytes (e.g., polycarbonates). In some embodiments, the material can provide self-healing by being able to swell. For instance, sodium alginate can be included to heal small cracks (cracks on the scale of about 30 μm to about 50 μm) and large pores (pores up to about 150 μm). Mignon et al. (Materials Research Society Symposium Proceedings, 2016, 1813:28-33) describes the use of sodium alginate and calcium alginate gels at 0.5 wt % and 1 wt % in cement admixtures. At 0.5 wt % sodium or calcium alginate, the corresponding cured mixtures were within 15% of target bending and flexural strength values. Accordingly, in some embodiments, the presently disclosed compositions comprising mineralized hemp fibers can further comprise one or more of sodium alginate powder, sodium alginate gel particles, calcium alginate gel particles, or calcium alginate gel fibers. Spun sodium alginate fibers can be coagulated in CaCl₂ solution to crosslink the sodium alginate fiber. In some embodiments, the composition can comprise about 0.5% to about 2% sodium and/or calcium alginate by weight of the total dry/solid components of the composition (e.g., about 0.5%, about 0.75%, about 1.0%, about 1.25%, about 1.5%, about 1.75%, or about 2% by weight of the total dry/solid components). In some embodiments, the composition can include a higher or lower % of sodium and/or calcium alginate.

In some embodiments (in any of the compositions described herein, e.g., in a cementitious composition described herein), some or all of the mineralized hemp fiber can be replaced by heat-treated mineralized hemp fiber (e.g., a calcined mineralized hemp fiber/a fiber that comprises a core comprising biochar and a coating covering at least a portion of the surface of the core comprising calcium oxide). Thus, in some embodiments, the presently disclosed subject matter provides a composition comprising a calcined mineralized hemp fiber.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter.

### Methods and Materials

Unless otherwise noted, the hemp fiber was decorticated hemp fiber sourced from BastCore (Montgomery, Alabama, United States of America), while calcium chloride (CaCl₂) and sodium carbonate (Na₂CO₃) were from Sigma-Aldrich (St. Louis, Missouri, United States of America) and Fisher Chemicals (Thermo Fisher Scientific Inc., Waltham, Massachusetts, United States of America). Salt solutions were prepared using deionized water. The hemp fiber used to prepare “Hemp C” described herein was sourced from Hemp Ventures, Inc. (Omaha, Nebraska, United States of America).

“Bench-top” scale protocols described herein are typically intended for mineralizing relatively smaller amounts of hemp fiber (e.g., 300 grams or less). “Pilot” scale protocols can be performed on larger amounts of hemp fiber if desired (e.g., 300 grams or more or 500 grams or more).

### Mineralization Degree:

Batts of hemp fiber that were not mineralized are referred to as untreated or un-mineralized. For mineralized hemp, degree of mineralization or “mineralization degree” (% MD) was used to characterize the relative mass of CaCO₃ to hemp. % MD was calculated using Equation 1, below wherein Wm and Wo are the dry weights of the mineralized and untreated hemp fibers, respectively.

$$\% MD = \frac{Wm - Wo}{Wo} \times 100 \qquad Equation 1$$

### Imaging:

The surface morphology of un-mineralized and mineralized hemp fibers was imaged by scanning electron microscope (SEM) using a Hitachi SU3900 variable pressure scanning electron microscope (VPSEM) (Hitachi, Ltd., Tokyo, Japan).

### Vibrational Spectroscopy:

Fourier transform infrared spectroscopy (FTIR) spectra were collected using a iS10 FTIR spectrometer (Thermo Fisher; Thermo Fisher Scientific, Waltham, Massachusetts, United States of America) equipped with an attenuated total reflectance (ATR) accessory sold under the tradename MIRACLE™ (Pike Technologies, Madison, Wisconsin, United States of America) that incorporated a germanium (Ge) crystal plate as the reflector. Six measurements at different locations for each sample were conducted over the spectral range of 4000-400 cm⁻¹ at 4 cm⁻¹ resolution and with 32 scans. Additional absorbance spectra were obtained using a FTIR spectrophotometer sold under the tradename IRAFFINITY-1™ (Shimadzu Corporation, Kyoto, Japan).

### X-Ray Diffraction:

An X-ray diffractometer (sold under the tradename SMARTLAB™ (Rigaku, Tokyo, Japan) was used to analyze the crystal structures of hemp cellulose and CaCO₃, using Bragg-Brentano focusing optics and an SC-70 detector. Wide-angle X-ray diffractions were conducted with experimental parameters that included Cu Kα radiation with a wavelength of λ=1.541862 Å, a generator operated at 40 kV with a beam current of 44 mA, and angular scanning within the 26 range of 5-50°, with a step size of 0.0500°.

### Chemical Analysis:

X-ray photoelectron spectroscopy (XPS) was performed with a system sold under the tradename SPECS™ (SPECS GmbH, Berlin, Germany) with a PHOIBOS 150 analyzer to conduct a chemical analysis of mineralized hemp fibers. To compare mineralized samples, the binding energies of carbon (C 1s), oxygen (O 1s), and calcium (Ca 2p) were examined.

### Physical Testing:

Fiber mechanical properties were evaluated to determine physical characteristics. The fiber linear density, measured in grams per 10,000 meters (i.e., decitex), was determined using the vibromat ME (Textechno H. Stein GMBH & Co. KG, Moenchengladbach, Germany). Hemp fiber strength was evaluated in terms of fiber tenacity, specific modulus, toughness, and strain at break, with mechanical testing conducted on the MTS Q test machine in accordance with ASTM D3822 methods. Un-mineralized and mineralized hemp fibers were assessed for mechanical performance, and the resulting data is described below.

### EXAMPLE

### Carding of Hemp Fiber

Carding can be performed to prevent cohesion and entanglement of fibers. Hemp fiber batts were manually opened to provide handfuls of hemp to feed into the carder. According to an exemplary procedure, hemp fiber (6.289 g) was feed into a drum carder (Ashford Wild Carder; Ashford, Ashburton, New Zealand). The carding was performed by hand and the level of carding was adjusted based on the number of drum rotations: 10, 20, 30, 40, or 50 turns. As the number of turns increased, the fiber became more parallel. See FIGS. 1I-1K. See also FIGS. 1G and 1H.

### Example 2

### Cement Pore Water Recipe

TABLE 1A
Cement pore water recipe.

| Cement | Water/ | Silica Wt % | | |
|---|---|---|---|---|
| Content | cement | Cement + | | |
| kg/m³ | Ratio | silica | Chloride (wt %) | |
| 360 | 0.35 | 0 | 0.2 | 0.5 |
| 360 | 0.35 | 10 | 0.2 | 0.5 |
| 340 | 0.45 | 20 | 0.2 | 0.5 |
| 300 | 0.6 | 30 | 0.2 | 0.5 |

TABLE 1B
Cement pore recipe

| Cement | | Silica (g) | Chloride | |
|---|---|---|---|---|
| Content | Water | Cement + | (2% NaCl) | |
| (g) | (ml) | silica | (ml) | |
| 24.984 | 8.7 | | 0.05 | 0.24984 |
| 24.984 | 8.7 | | 0.05 | 0.24984 |
| 23.596 | 10.6 | | 0.047 | 0.23596 |
| 20.82 | 12.5 | | 0.042 | 0.2082 |

2 g of NaCl in 100 mL of DI gives a concentration of 2 × 10⁴ ppm and an initial chloride ion concentration of 1.21 × 10⁴ ppm.

Tables 1A and 1B, above, show compositions developed as “cement pare water” for use herein to study mineralized hemp fiber under concrete preparation conditions. In the upper-most composition, there was 0% silica. This can be used to help study the effect of the presence and absence of the silica in the cement water recipe, from the 2^{nd} to fourth composition, there was a 10% increase of silica, which can show the effect of increase in silica content. The chloride content was varied from low to high to show the effect of low and high chloride content

### Example 3

### Mineralization of Hemp Fiber: Dipping Protocol

Exemplary Reactions for the formation of Calcium Carbonate:

Na₂CO₃(aq)+CaCl₂→CaCO₃(s)+2NaCl(aq)

K₂CO₃(aq)+CaCl₂→CaCO₃(s)+2KCl(aq)

CS₂CO₃(aq)+CaCl₂→CaCO₃(s)+2CsCl(aq)

### Dipping Protocol for Mineralization (Long Hemp Fiber)

### Trial A:

The carded hemp long fibers (10-50 times) were mineralized as follows: 10 turns carded fiber was soaked in deionized (DI) water for 2 minutes at room temperature. The fiber was then dipped in 140 mM aqueous CaCl₂ solution for 40 seconds. The fiber was then rinsed in a water bath for 1 minute followed by dipping in a 140 mM aqueous Na₂CO₃ solution for 40 seconds. The fiber was rinsed again in a separate water bath for 1 minute. The dipping was performed while the fiber was placed in a coarse mesh, after which it was allowed to dry overnight at room temperature. The five-step cycle was performed once and sample kept for further action.

### Trial B

A 10 turns carded long hemp fiber was dipped in 140 mM aqueous CaCl₂ solution for 40 seconds, rinsed in a water bath for 1 minute, dipped in a 140 mM Na₂CO₃ solution for 40 seconds, and rinsed again in a separate water bath for 1 minute. The four-step dipping cycle was performed 5 times and the sample was left to dry overnight.

Note: The initial and final weight of the sample was taken and used to determine the mineralization degree (MD). The 4 step dipping cycles were performed 5 times on each of 10 turns (10T) carded long fiber, 20 turns (20T) carded long fiber; 30 turns (30T) carded fiber, 40 turns (40T) carded fiber, and 50 turns carded fiber. Results are shown in Table 2, below.

TABLE 2
Results From Dipping Mineralization Trial B.

| Sample | Initial | Final | Difference | | |
|---|---|---|---|---|---|
| (carded | weight | Weight | in weight | MD | |
| turns) | of fiber (g) | (g) | (g) | (%) | Dimension |
| 10 | 1.06 | 1.162 | 0.102 | 9.6 | 13 cm × 13 cm |
| 20 | 1.06 | 1.218 | 0.158 | 14.9 | 13 cm × 13 cm |
| 30 | 1.06 | 1.286 | 0.226 | 21.3 | 13 cm × 13 cm |
| 40 | 1.06 | 1.227 | 0.167 | 15.8 | 13 cm × 13 cm |
| 50 | 1.06 | 1.260 | 0.2 | 18.9 | 13 cm × 13 cm |

### Trial C

Trial B was repeated only using short hemp fiber. Results are shown in Table 3, below.

TABLE 3
Results of Dipping Mineralization Trial C.

| Sample | Initial | Final | Difference | | |
|---|---|---|---|---|---|
| (carded | weight | Weight | in weight | MD | |
| turns) | of fiber (g) | (g) | (g) | (%) | Dimension |
| 10 | 0.757 | 0.837 | 0.08 | 10.6 | 11 cm × 11 cm |
| 20 | 1.1301 | 1.263 | 0.127 | 11.2 | 11 cm × 11 cm |
| 30 | 1.1508 | 1.370 | 0.2192 | 19.0 | 11 cm × 11 cm |
| 40 | 1.2318 | 1.360 | 0.1282 | 10.4 | 11 cm × 11 cm |
| 50 | 0.807 | 0.962 | 0.155 | 19.2 | 11 cm × 11 cm |

### Standard “4-Step” Dipping Protocol (Bench-Top Scale):

The following dipping cycle was performed using short fibers:
Dip the hemp fiber into 140 mM aqueous CaCl₂ for 40 seconds and drain for 40 seconds.
Rinse with water for 40 seconds and drain for 40 seconds.
Dip in 140 mM aqueous Na₂CO₃ solution for 40 seconds and drain 40 seconds
Rinse with water again for 40 seconds and drain 40 seconds.
Remove, drain and allow to dry.

This single cycle protocol was repeated to achieve 5, 10, 15, and 20 total dipping cycles. The dipping protocol was also performed replacing Na₂CO₃ with K₂CO₃ or by using long hemp fibers. Exemplary results are described in Tables 4-7, below.

TABLE 4
Results from Mineralization with Long
Fibers, Four Step Dipping Cycle (5 cycles)

| Sample | Initial | Final | Difference | | |
|---|---|---|---|---|---|
| (carded | weight | Weight | in weight | MD | |
| turns) | of fiber (g) | (g) | (g) | (%) | Dimension |
| 10 | 1.06 | 1.104 | 0.044 | 4.2 | 13 cm × 13 cm |
| 20 | 1.06 | 1.092 | 0.032 | 3.0 | 13 cm × 13 cm |
| 30 | 1.06 | 1.076 | 0.016 | 1.5 | 13 cm × 13 cm |
| 40 | 1.06 | 1.074 | 0.014 | 1.3 | 13 cm × 13 cm |
| 50 | 1.06 | 1.180 | 0.12 | 11.3 | 13 cm × 13 cm |

TABLE 5
Results from Mineralization of Long Fibers,
Four Step Dipping Cycle (10 cycles)

| Sample | Initial | Final | Difference | | |
|---|---|---|---|---|---|
| (carded | weight | Weight | in weight | MD | |
| turns) | of fiber (g) | (g) | (g) | (%) | Dimension |
| 10 | 1.06 | 1.193 | 0.133 | 12.5 | 13 cm × 13 cm |
| 20 | 1.06 | 1.172 | 0.112 | 10.6 | 13 cm × 13 cm |
| 30 | 1.06 | 1.224 | 0.164 | 15.5 | 13 cm × 13 cm |
| 40 | 1.06 | 1.287 | 0.227 | 21.4 | 13 cm × 13 cm |
| 50 | 1.06 | 1.491 | 0.431 | 40.7 | 13 cm × 13 cm |

TABLE 6
Results from Mineralization of Short Fibers,
Four Step Dipping Cycle (5 cycles)

| Sample | Initial | Final | Difference | | |
|---|---|---|---|---|---|
| (carded | weight | Weight | in weight | MD | |
| turns) | of fiber (g) | (g) | (g) | (%) | Dimension |
| 10 | 1.06 | 1.069 | 0.009 | 0.85 | 11 cm × 11 cm |
| 20 | 1.06 | 1.135 | 0.075 | 7.1 | 11 cm × 11 cm |
| 30 | 1.06 | 1.095 | 0.035 | 3.3 | 11 cm × 11 cm |
| 40 | 1.06 | 1.075 | 0.015 | 1.4 | 11 cm × 11 cm |
| 50 | 1.06 | 1.093 | 0.033 | 3.1 | 11 cm × 11 cm |

TABLE 7
Results from Mineralization of Short Fibers,
Four Step Dipping Cycle (10 cycles)

| Sample | Initial | Final | Difference | | |
|---|---|---|---|---|---|
| (carded | weight | Weight | in weight | MD | |
| turns) | of fiber (g) | (g) | (g) | (%) | Dimension |
| 10 | 1.06 | 1.350 | 0.29 | 27.4 | 11 cm × 11 cm |
| 20 | 1.06 | 1.310 | 0.25 | 23.4 | 11 cm × 11 cm |
| 30 | 1.06 | 1.40 | 0.34 | 32.5 | 11 cm × 11 cm |
| 40 | 1.06 | 1.413 | 0.353 | 33.3 | 11 cm × 11 cm |
| 50 | 1.06 | 1.429 | 0.36 | 34.0 | 11 cm × 11 cm |

Pilot scale mineralization via the dipping protocol was also performed on larger amounts of fiber by adjusting the dipping protocol as follows: 1 minute for immersion (of fibers in sachets being immersed in vats of metal salt solution and/or rinse water) and 1 minute for setting the fibers prior to dipping into the next solution.

### Example 4

### Mineralization of Hemp Fiber: Spraying Protocol

In addition to mineralization via the dipping protocol described in Example 3, hemp fiber was also mineralized using an alternative spraying protocol. In the bench-top scale spraying protocol, CaCO₃ mineralization was performed by placing a hemp fiber batt (e.g., a carded hemp fiber batt) onto a screen (e.g., a vertically oriented mesh screen) and alternately spraying it with an aqueous solution of CaCl₂ and an aqueous solution of a metal carbonate (e.g., for about 2 or more seconds, such as about 2 to 20 seconds). According to an exemplary spraying procedure, a 1.06 g batt of carded hemp fiber was placed onto a screen and sprayed (using a handheld pump sprayer) with 140 mM of CaCl₂ for 20 seconds (s), and excess solution was allowed to drain for 20 s. The spraying cycle was completed by spraying the hemp fiber with a 140 mM aqueous solution of Na₂CO₃ for 20 s and draining for 20 s. This spraying cycle was repeated to reach 5, 10, 15, or 20 total cycles. The sprayed hemp fiber was dried at room temperature after the desired number of spraying cycles for 24 hours.

Compared to the dipping protocol, the spraying approach reduces cycle time by 160 seconds and requires fewer personnel while achieving an impressive percentage degree of mineralization (% MD) increase of up to approximately 170% (i.e., 172.5% MD for a sample where a short fiber was carded for 40 turns and mineralized via the spraying cycle for 20 cycles (SF-40R-20SC). A long fiber sample carded for 20 turns and mineralized via the spraying cycle (LF-20R-20SC) had a % MD of 109.6% MD (i.e., about 110% MD).

Pilot Scale mineralization was also performed using the spraying procedure. For amounts of fiber of about 300 grams or less, each pilot spray step was for 1 minute with 30 seconds for draining for up to 20 cycles. If larger amounts (e.g., pounds) of fiber are used, a similar protocol can be used if the fiber thickness on the screen is less than 0.5 to 1 inch thick.

### Example 5

### Characterization of Mineralized Hemp Fiber

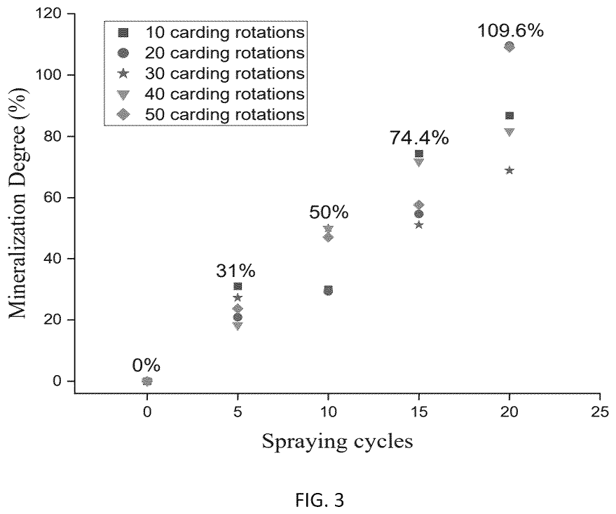

Bundles of hemp fibers mineralized using the spraying or dipping protocols were studied via scanning electron microscopy (SEM) to observe the surface for CaCO₃ coating. All samples showed coating which increased with increasing mineralization cycles. See also FIGS. 1A-1D, 1L, 1M, and 3. For instance, FIG. 3 shows the mineralization degree obtained from 0-20 spraying cycles. Although the degree of opening (number of carding rotations) did have some impact on mineralization, there was no significant detectable trend in the effect due to degree of opening. Without being bound to any one theory, it is believed that the lack of a significant trend can be attributed to the variability in pressure during spraying. However, a trend for increased % MD was observed as the number of spraying cycles increased. This finding suggests that once a crystal unit is formed, it provides space for forming more crystals.

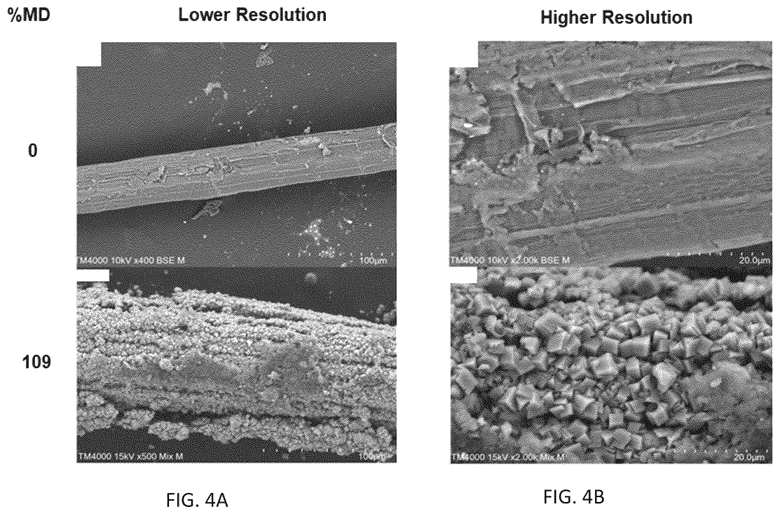

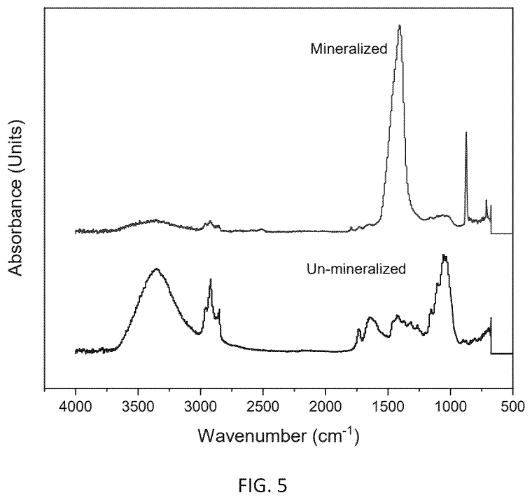

Generally, CaCO₃ mineralization via spraying the surface of hemp fiber with alternating precursor solutions resulted in a greater degree of mineralization, e.g., with the % MD of 109.6% MD for long fibers mineralized via 20 spraying cycles compared to 44.6% MD achieved by the dipping method. Large crystal deposition can be clearly seen in FIGS. 4A and 4B. Without being bound to any one theory, the increase in mineralization for fibers mineralized via the spraying procedure is attributed to a lack of the water rinsing step used in the dipping protocol, allowing for the formation of more CaCO₃ crystals. The observed hexagonal habit of the crystals (see FIG. 4B) suggests the presence of calcite, with a few spherical crystals indicating vaterite, which can play a role as a precursor in calcite formation (recrystallization of vaterite to calcite during aging).^{27,28} This, in addition to the use of NaCO₃ in the final spraying stage, is believed to contribute to the improvement in mineralization percentage. The quantity and coverage of the CaCO₃ crystals on the hemp fiber surface also significantly increased.

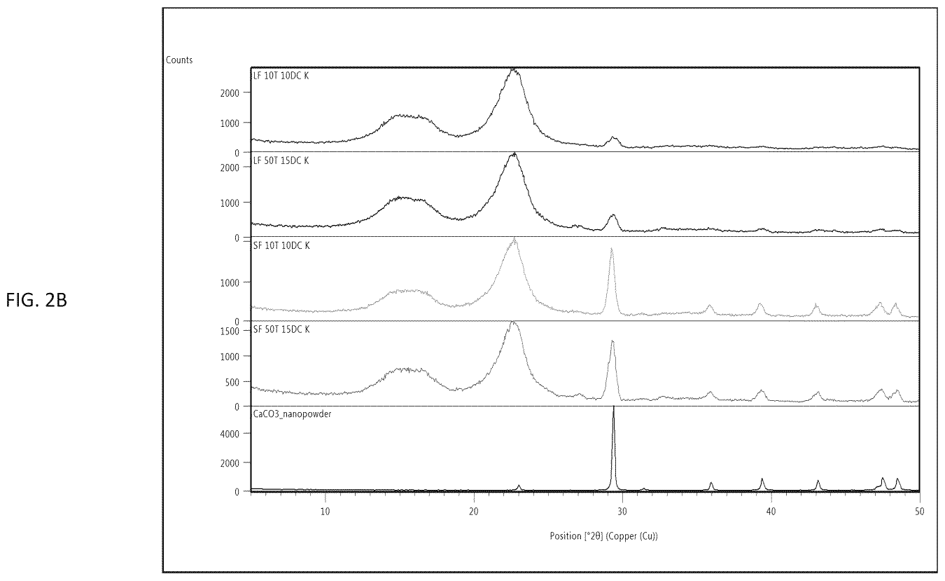

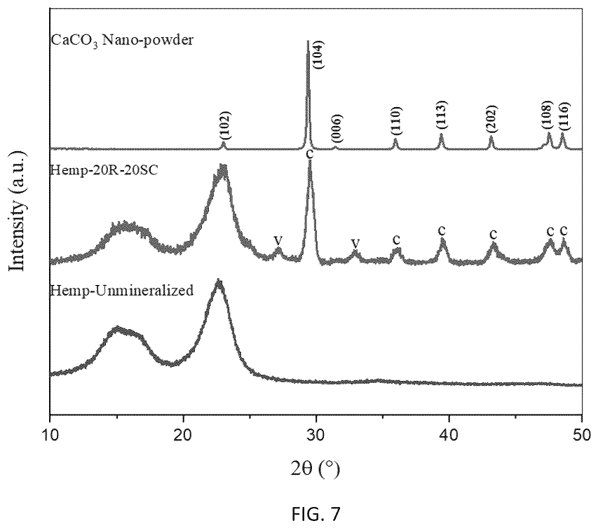

X-ray diffraction (XRD) scans were performed to identify the crystal types present in the samples. CaCO₃ nano powder (calcite polymorph, 15-40 nm, 97.5% purity, part number CA-CB-0175-NP.040N by American Elements (Los Angeles, California, United States of America)) served as control. See FIGS. 2A, 2B, and 7. The absorption spectra of un-mineralized and CaCO₃ mineralized hemp fiber are shown in FIG. 5. Carbonate ions and similar molecules have four normal modes of vibration peaks: symmetric stretching (vi), out-of-plane bending (ν2), doubly degenerate planar asymmetric stretching (ν3), and doubly degenerate planar bending (ν4).²⁹ Calcite displays distinct absorption bands at υ2 875 cm⁻¹ and υ4 713 cm⁻¹, along with an absorption peak at 1420 cm⁻¹. Meanwhile, vaterite showcases absorption bands at υ2 875 cm⁻¹ and υ4 745 cm⁻¹, as well as a split peak of υ3 at 1440 and 1490 cm⁻¹. These are the typical features of CO₃²⁻ ions in CaCO₃ and represent the fundamental modes of vibration for this molecule.^{27,30} Additionally, the unmineralized hemp fiber showed the presence of the OH group (3100-3500 cm⁻¹) from the cellulose, which disappeared in the mineralized hemp fiber. This indicates the utilization of the OH group in the CaCO₃ crystal formation, as supported by the high-resolution XPS spectra in FIG. 7.

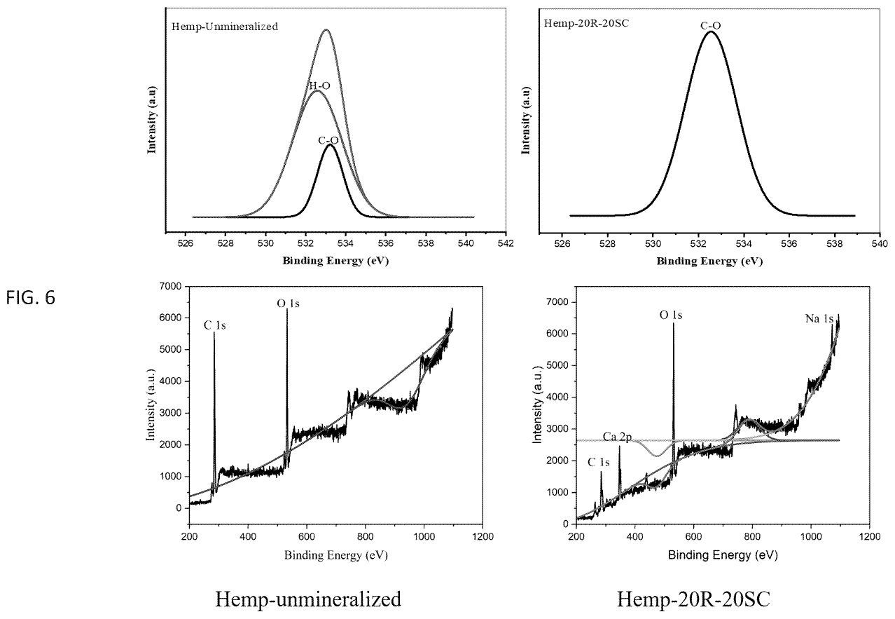

Based on the XPS spectra of the unmineralized and mineralized hemp fiber (see FIG. 6), it was observed that additional peaks of Ca 2p and Na 1s were present, which are related to the calcium ions (Ca 2+ ions) and Na+ ions resulting from the final step of the mineralization method, involving the spraying of Na₂CO₃ precursor solution. The presence of Na was not seen in the dipping method. The Na ions play a role in the continuous generation of CaCO₃ crystals on the surface of the hemp fiber. Furthermore, high-resolution scans of the 01s spectrum revealed the presence of C—O (−533 eV) and O—H (cellulose) on the unmineralized hemp fiber. In contrast, the mineralized sample (Hemp-20R-20SC) showed only C—O (−531.5-535 eV), indicating the presence of metal carbonate, specifically CaCO₃. Additionally, the O—H peak disappeared on the mineralized hemp fiber, suggesting that the hemp fiber is completely covered with CaCO₃ crystals.

To assess the presence of various CaCO₃ mineralization polymorphs, XRD analysis was performed on un-mineralized and mineralized hemp fiber, along with reagent-grade CaCO₃ powder, as depicted in FIG. 7. The XRD patterns revealed that the reagent-grade CaCO₃ powder displayed peaks at 23.0°, 29.4°, 31.6°, 36.0°, 39.4°, 43.3°, 47.5°, and 48.6°, corresponding to (102), (104), (006), (110), (113), (202), (108), and (116) lattice planes of pure-phase calcite. The mineralized hemp fiber exhibited a distinct calcite diffraction pattern identical to that of the reagent-grade CaCO₃. Additionally, it showed extra peaks at 27.1° and 32.7°, representing the (112) and (114) crystal planes of vaterite. Conversely, the un-mineralized hemp displayed peaks at 14.7°, 16.6°, 22.7°, and 34.8°, which were attributed to the (1-10), (110), (200), and (004) crystal planes of cellulose Iβ. These findings indicate that the mineralized hemp fiber yielded a mixture of calcite (predominant) and vaterite (minor) polymorphs. The intensity of calcite was greater in the mineralized hemp fiber compared to vaterite. To determine the percentage of calcite (XC) and vaterite (XV), the integrated peak area of the two polymorphs was calculated using their respective score values obtained from the XRD data, as described in following equation:

$$Percentage polymorphs ( XC or XV ) = ( \frac{Score value of polymorh}{Total score value of polymorphs} ) \times 100$$

Here, X represents the percentage, while C and V denote calcite and vaterite polymorphs, respectively. The calculated XC value for the mineralized hemp fiber prepared at a bench top scale using the spraying protocol is 56%, whereas that of XV is 44%. Table 8, below, shows the calculated amounts of calcite and vaterite polymorphs in mineralized hemp fibers prepared by either the spraying or dipping protocol and at either a bench top scale or a pilot scale.

TABLE 8
Calcium Carbonate Polymorph Content of Mineralized Hemp

| Mineralization | | Calcite | Vaterite |
|---|---|---|---|
| Protocol | Scale | (%) | (%) |
| spraying | Bench top | 56 | 44 |
| dipping | Bench top | 90 | 10 |
| spraying | Pilot | 100 | 0 |
| dipping | Pilot | 87 | 13 |

### Dispersion in Liquid/Medium (Water)

Dispersion tests were performed to observe how separated the fiber can be in water in view of the cement mixing stage. Samples were placed in 300 ml water in a ceramic bowl and stirred with a stirring rod for 5 minutes and observed. The following samples were studied:
Short fiber-uncarded
Short Fiber-carded 10 turn
Short fiber carded 10 turn and best mineralized
Short fiber carded 30 turns and the least mineralized
Short fiber carded 30 turns

The uncarded fiber had poor separation. The carded fiber showed better separation with increasing number of turns. The mineralized fiber showed good separation, with the best mineralized sample showing the best separation. In general, unlike unmineralized fibers, fibers mineralized with CaCO₃ were less entangled and the fibers spread in water with mechanical stirring better. Mineralized fibers also mixed with cement admixtures better.

### Tensile Properties

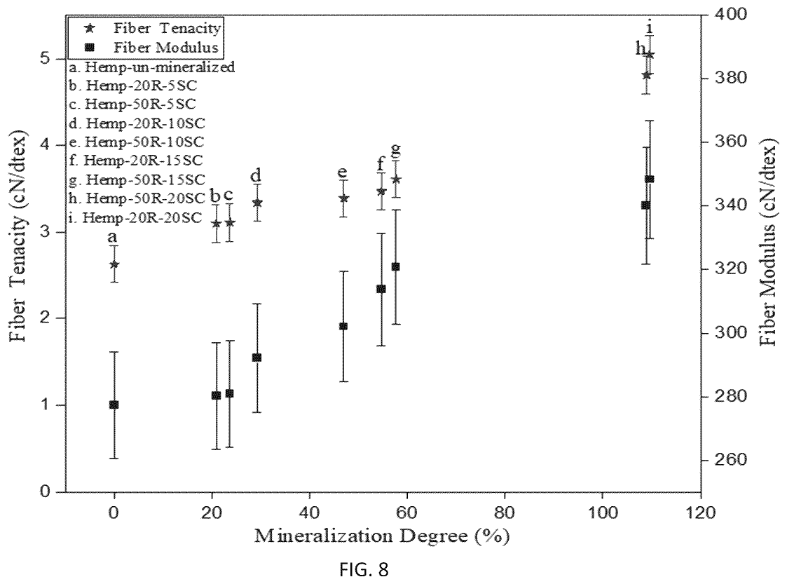

FIG. 8 compares the mechanical strength of un-mineralized (Hemp-unmineralized) and mineralized (hemp carded for 20 turns and mineralized via 20 spraying cycles (Hemp-20R-20SC)) hemp fibers. The results showed that with 109.6% mineralization, there was an increase in stiffness or modulus from 277.29 cN/dtex for the un-mineralized hemp (Hemp-unmineralized) fiber to 348.38 cN/dtex for the mineralized hemp fiber. Without being bound to any one theory, this increase is attributed to the deposited CaCO₃ crystal and the chemical interaction between the crystal and organic hemp fiber. Mineralization also produced a tough hemp fiber that can absorb significant energy before rupturing, increasing the toughness from 0.018 cN/dtex to 0.053 cN/dtex. Additionally, the CaCO₃ minerals can create more complex fracture paths, leading to an increase in toughness, and can alter the way cracks propagate within the structure, leading to an improved toughness. The mineralized (Hemp-20R-20SC) hemp fiber showed a higher strain at break of 2.54% compared to the un-mineralized (Hemp-unmineralized) hemp fiber with 1.16%, which signifies better ductility in the material. Finally, mineralized (Hemp-20R-20SC) hemp fiber exhibited a better tenacity of 5.05 cN/dtex compared to 3.53 cN/dtex for un-mineralized (Hemp-unmineralized) hemp fiber, indicating it can withstand more stress before breaking. Tables 9 and 10, below, summarize the strength values of dipped and sprayed hemp fibers at higher levels of mineralization. Overall, the findings suggest that mineralization can improve the mechanical properties of hemp fiber.

TABLE 9
Mechanical Properties of Mineralized Hemp Fiber (Dipping Procedure)

| | | Average | Linear | | Specific |
|---|---|---|---|---|---|
| | % | Length | Density | Tenacity | Modulus |
| Sample | MD | (mm) | (den) | (cN/dtex) | (cN/dtex) |
| Control | 0 | 26.01 ± 0.01 | 22.8 ± 9.5 | 2.22 ± 0.85 | 120.95 ± 57.2 |
| Mineralized | 45 | — | 27.5 ± 10 | 3.89 ± 1.04 | 254.97 ± 114.9 |

TABLE 10
Mechanical Properties of Mineralized Hemp Fiber (Spraying Procedure)

| | | Average | Linear | | Specific |
|---|---|---|---|---|---|
| | % | Length | Density | Tenacity | Modulus |
| Sample | MD | (mm) | (den) | (cN/dtex) | (cN/dtex) |
| Control | 0 | 30.3 ± 0.01 | 23.79 ± 7.36 | 2.63 ± 1.24 | 277.26 ± 110.09 |
| Mineralized | 110 | — | 27.65 ± 7.00 | 5.05 ± 1.24 | 348.34 ± 109.9 |

### Example 6

### Mineralization Effects on Fiber Strength in Different Liquid Conditions

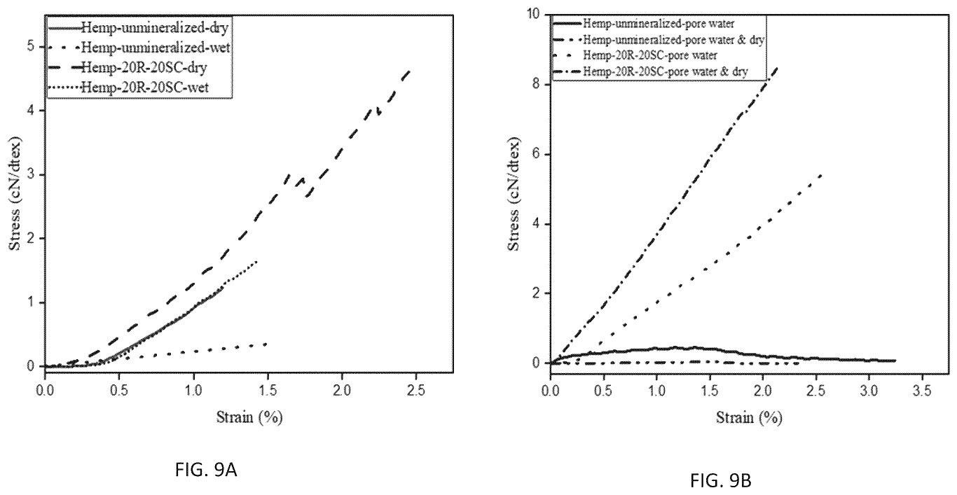

Tensile testing of select dry mineralized hemp fibers prepared on bench top scale and with different carding and mineralization conditions are summarized in Tables 9 and 10, above, and in FIGS. 8, 9A, and 9B.

Tensile testing was performed according to ASTM D3822 using a MTS Q-Test/5 CRE tester for single fiber/filament tensile, using a 5-lbs load cell, a 1-inch gauge/length, and a 2.54 mm/min crosshead speed. “Dry” tensile testing was performed on fibers that had been under conditions of 70° F., 65% relative humidity (RH) for 18 hours prior to testing. Dry fibers were treated with deionized water for 20 minutes or with cement pore water prior to mechanical testing. For cement pore water testing:
(1) a saturated Ca(OH)₂ solution was prepared and KOH and NaOH were added according to the desired alkalinity of the cement mixture;
(2) hemp fibers were soaked in the Cement Pore Water (see Table 11, below) for 20 minutes;
(3) fiber samples were drained and mounted on 1-inch laminated tabs. A paper towel was used to dry off excess moisture from the tabs before mechanical testing;
(4) single fiber mechanical testing was performed according to ASTM D3822 on the MTS Q-Test apparatus;
(5) hemp fibers were also tested after drying the pore water treatment onto the fibers at ambient conditions prior to mechanical testing (i.e., for the Pore Water & Dry conditions).

TABLE 11
Cement Pore Water Recipe:

| | | Silica (g) | Cloride | |
|---|---|---|---|---|
| Cement | Water | Cement + | (2% NaCl) | |
| Content (g) | (ml) | Silica | (ml) | |
| 20.82 | 12.5 | 6.246 | 0.042 | 0.2082 |

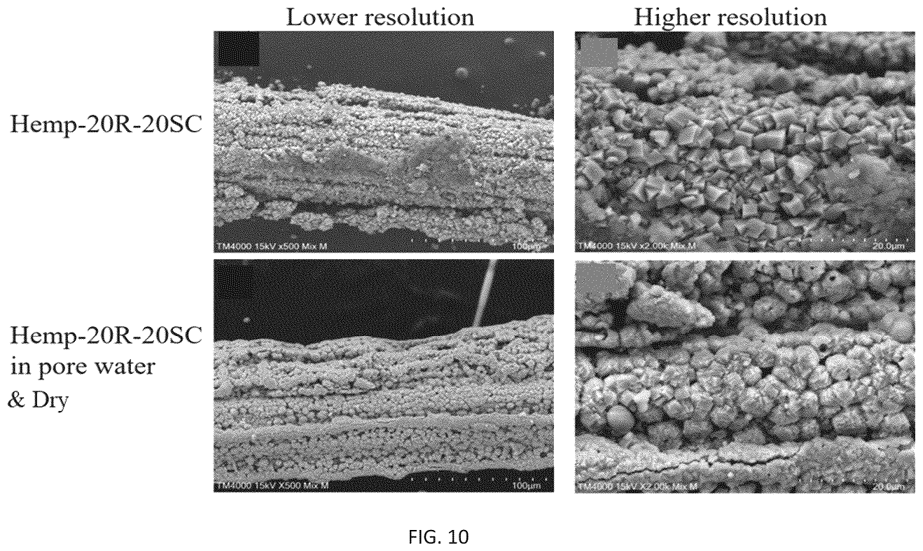

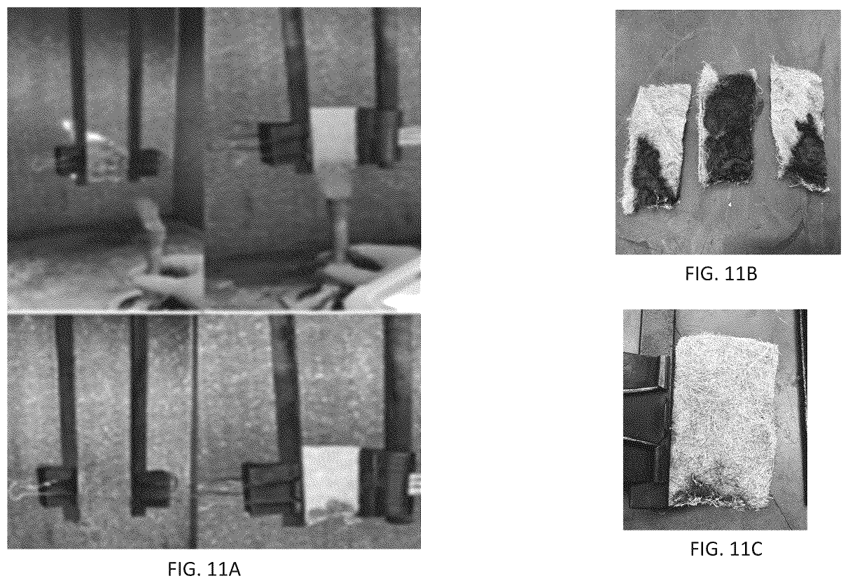

Linear density was measured using a Textechno Vibromat ME, which measures fiber linear density, according to ASTM D1577 (“Linear Density of Textile Fiber: Option C-Vibroscope). Results of spectroscopy studies on the effects of liquid treatment condition on mineralized hemp fibers are shown in FIG. 10.

### Discussion:

When hemp fiber is sprayed with a calcium chloride (CaCl₂) solution, it swells significantly, which allows calcium ions (Ca²⁺) to penetrate the non-crystalline areas within the fibers. When a sodium carbonate (Na₂CO₃) solution is then sprayed on the CaCl₂, a double displacement reaction occurs, leading to the formation of calcium carbonate (CaCO₃) within the fibers. This process mineralizes the hemp fiber with CaCO₃ crystals, increasing the crystallinity of the CaCO₃ mineralized hemp fibers and enhancing their mechanical properties.³¹ The stress-strain curves for the mineralized hemp fiber (Hemp-20R-20SC) under different conditions are depicted in FIGS. 9A and 9B. FIG. 9A illustrates the mineralized hemp fiber in both dry and wet conditions. The results indicate that both un-mineralized and mineralized hemp fibers exhibit reduced strength when wet. Despite the expectation of brittleness due to the presence of calcium carbonate (CaCO₃) crystals, the mineralized fibers proved to be stiff, demonstrating their suitability for applications that require strength, such as in textiles or composite materials.^{32,33} This unexpected flexibility can be attributed to the deposition or dispersion of calcium carbonate (CaCO₃) crystals within the amorphous region of the hemp fiber surface, filling small gaps and pores, as well as other defective areas generated during hemp fiber processing. The presence of calcium carbonate enhances mechanical properties without creating rigid areas that would impede flexibility.³¹ Consequently, during mechanical testing, the load of the defective parts is transferred to the calcium carbonate (CaCO₃) crystals, predominantly calcite with a stable structure, effectively preventing rapid deformation and fracture of the weaker parts of the hemp fiber, thereby improving tenacity and specific modulus. In FIG. 9B, the hemp fibers were tested under pore water conditions. The untreated hemp fiber, when exposed to pore water and then allowed to dry for 24 hours, showed a decrease in strength due to water disrupting the hydrogen bonds between the cellulose chains. This led to reduced structural integrity but increased flexibility, as the absorbed water acted as a plasticizer.³⁴ Conversely, the mineralized hemp fiber exhibited improved mechanical properties when treated under pore water conditions. This improvement could be attributed to the alkaline nature of the pore water (pH 12), which led to the continuous precipitation of calcium carbonate.²⁷ Evidence from SEM images in FIG. 10 showed that the mineralized hemp fiber treated in pore water conditions tended to develop more calcium carbonate (CaCO₃) crystals, which realigned themselves and stabilized³³ the fiber in poor water conditions, ultimately enhancing its mechanical performance. Treatment of the mineralized fiber with acid (e.g., acetic acid or hydrochloric acid) led to removal of the calcium carbonate. Removal of CaCO₃ by acid treatment confirmed the formation of hemp fiber with mineral deposits on its surface, without any damage to the fiber surface.

The present studies indicate that the mechanical strength of hemp fiber with calcium carbonate (CaCO₃) mineralization, particularly when mineralized via the presently disclosed spraying protocol, have improved tenacity. This suggests that the mineralization process positively impacts the mechanical properties of the hemp fiber. The mineralization utilizing non-toxic chemicals and a simple, one-step process for producing organic-inorganic hybrid fibers further demonstrates the potential for cost-effective and environmentally friendly large-scale production. Additionally, the comparison of various mineralization procedures for functionalizing natural fibers and the properties they enhance provides valuable insights for the development of cost effective and environmentally friendly alternative high-performance materials.

### Example 7

### Flame Retardancy of Mineralized Hemp Fibers

Flame retardancy of unmineralized and mineralized hemp fibers was studied using the ASTM D-6413 protocol for vertical flame testing. Briefly, a 4 cm×8 cm batt of fiber was held in place between two vertical supports over a Bunsen burner. Control (unmineralized) hemp was fully engulfed in flame after 3 seconds and consumed within 20 seconds. See FIG. 11A. The mineralized hemp fiber sample on the right side of FIG. 11A was prepared via the spraying procedure on bench scale. Mineralized hemp fiber bats, prepared by either the dipping or spraying protocols on a pilot scale remained largely intact after 20 seconds, although sustained some charring, particularly in samples mineralized via dipping cycles. See FIGS. 11B and 11C. Overall, it appears that samples with higher levels of calcite exhibited improved flame retardancy.

### Example 8

### Green Concrete Studies

### Materials and Methods:

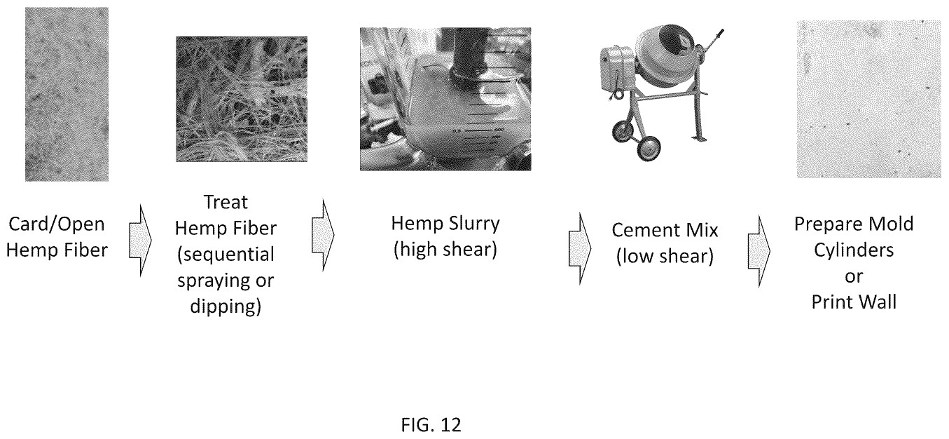

An exemplary “green” concrete can be prepared as shown in FIG. 12.

Two different mineralized hemp fiber materials (one (referred to herein as “Hemp A”) prepared by the dipping protocol on a pilot scale using short (26 mm) hemp fiber from BastCore opened on the Trützschler High-Speed Nonwoven Card EWK 413 (Trützschler Group SE, Mönchengladbach, Germany) and one (referred to herein as “Hemp C”) prepared by the spraying protocol on a pilot scale using hemp fiber from Hemp Ventures Inc., (Omaha, Nebraska, United States of America)) were evaluated for their impact on cement paste and mortar properties.

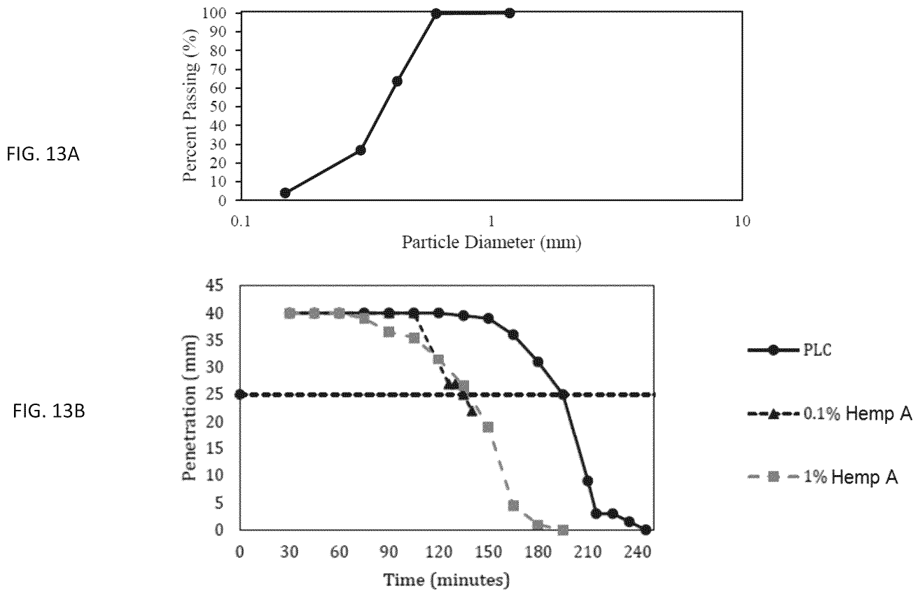

A blended Type IL Portland limestone cement meeting ASTM C595 standards³⁸ was used throughout the study. A Quikcrete premium play sand, which was sieved to meet the requirements for particle size distribution specified in ASTM C778 for graded sand,⁴² was used as a fine aggregate in all mortar cubes. The particle size distribution of the sand is shown in FIG. 13A. Specific gravity of the sand was determined to be 2.62 according to ASTM C128, and its absorption capacity was calculated to be 2.5%.⁴¹

Three dosages of fibers were tested for hemp mixtures, with proportions shown in Table 12. Testing performed for each mixture is shown in Table 13. All mixtures were based on the proportions required in ASTM C109,³⁹ and utilized a w/c of 0.485. Hemp fiber dosages were calculated as a mass proportion of the cement used in the mixture. Mixing and casting of samples for compressive strength (ASTM C109), flexural strength (ASTM C348)⁴³ and bulk resistivity testing (ASTM C1876³⁵) were performed according to ASTM C109. Hemp was added to the mixture in the last 60 seconds of mixing.

TABLE 12
Hemp Mortar Compositions.

| | 0.135% | 1% | 5% |
|---|---|---|---|
| | Hemp | Hemp | Hemp |
| Component | Mass (g) | | |
| Cement | 740 | 740 | 740 |
| Water | 359 | 359 | 359 |
| Sand | 2035 | 2035 | 2035 |
| Hemp | 1 | 10 | 50 |

TABLE 13
Testing Matrix.

| | Tests: | | | | | | |
|---|---|---|---|---|---|---|---|
| | Compressive | Bulk | Setting | | Flexural | Water | Sulfate |
| | Strength | Resistivity | Time | Flow | Strength | Expansion | Expansion |
| PLC | X | X | X | X | | | |
| 0.135% Hemp A | X | X | X | X | | | |
| 0.135% Hemp C | X | X | | X | | | |
| 1% Hemp A | X | X | X | X | X | X | X |
| 5% Hemp A | | | | | X | | |

For compressive strength and bulk resistivity testing samples, following mixing, a flow test was conducted (ASTM C1427⁴⁶). The flow test mortar was recombined with the remaining mortar, hand mixed, cast into sample molds, covered with plastic to prevent drying, and stored in a 72±3° F. curing room until demolding. Samples were demolded 24 hours following casting. Initial bulk resistivity measurements (ASTM C1876) were performed on mortar cubes following demolding. Cubes were then stored in a lime bath at 72±3° F. until testing at 7 and 28 days. Flexural strength samples were similarly tested at 7 and 28 days.

A Vicat apparatus was used to conduct setting time tests according to ASTM C191.⁴⁴ The ASTM C187⁴⁰ process was used to determine the normal consistency of the pastes for vicat testing. Vicat testing was performed on paste mixtures utilizing a hemp dosage equal to 0.135% of cement. Similar to the process of mixing the mortars, the hemp was added in the final stage of mixing of the pastes. Initial set was determined as the point where the Vicat needle penetrated into the sample 25 mm. Final set was where the needle did not penetrate into the surface of the hardened paste sample.

Water and sulfate expansion tests (ASTM C1038³⁶, ASTM C1012³⁷) were performed on mortars using the 1.0% hemp mortars, but scaled to produce the four bars required for the water absorption test and six bars required for sulfate expansion testing. 24 hours after casting, the samples were demolded, and water expansion tests followed at 7 and 14 days while the bars stayed in a lime water bath. For sulfate expansion measurements a sodium sulfate solution was formulated from 50.0 g of sodium sulfate was dissolved into 900 mL of distilled water, to result in a total of 1.0 L of solution. pH testing was conducted to ensure a neutral pH of 6-8. 24 hours after casting, the bars were demolded and expansion tests were performed at weeks 1, 2, 3, 4, 8, 13, and 15. The bars were held in the sodium sulfate solution for the entirety of the test and the sulfate solution was exchanged following each expansion measurement.

### Results:

Table 14 shows the impact of incorporation of the fibrous materials tested on the flow of the mixture. Changes in flow relative to a control mixture, in this case a portland limestone cement (PLC), indicate changes in the rheology of the mixture. Increases in flow relative to the control may translate to improvements in the ease with which a mixture can be placed and consolidated within concrete formwork. Alternatively, decreases in flow may suggest greater ability of the mixture to maintain its shape when 3D printed. Use of >0.1% dosages of fibers resulted in an approximately 10% reduction in flow. The general meaning of these results is that samples containing mineralized hemp fibers could benefit from more water or the use of a water reducing admixture chemical to maintain similar levels of flow relative to PLC mixtures if desired.

TABLE 14
Flow of Mortars compared to Portland
Limestone Cement (PLC) Control.

| | Flow (% of |
|---|---|
| Sample | Control PLC) |
| 0.1% Hemp A | 88 |
| 0.1% Hemp C | 94 |
| 1% Hemp A | 90 |

FIG. 13B shows the impact of the fibers on the setting time of pastes in which they were mixed. Use of either 0.1% or 1% of Hemp A reduced setting time relative to the PLC control by 55 minutes (from 195 minutes for the PLC control to ˜140 minutes for the average fibrous mixture). ASTM C1157 requires that cements have initial setting times not less than 45 min and not more than 420 min. Thus, mixtures utilizing these levels of hemp meet the specification's requirements. However, users of the hemp mortars should expect accelerated setting times relative to what would occur with use of mixtures without hemp fibers.

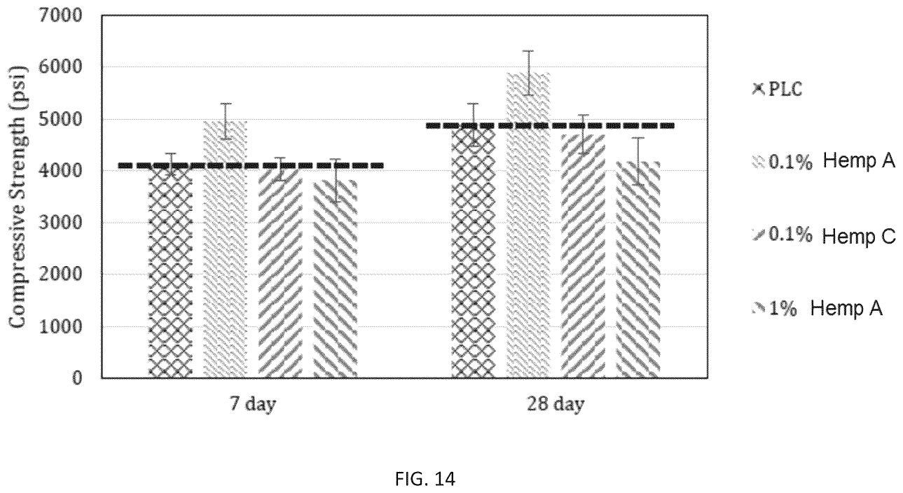

FIG. 14 shows the impact of fibers on the strength development in mortar cubes. Use of the Hemp A, at a dosage of 0.1% of cement weight increased the strength of the mixture relative to the control by approximately 1000 psi. Hemp C performed similar to the control PLC. Use of a higher dosage of the Hemp A (1% of cement weight) lowered strength, resulting in approximately 700 psi loss in strength at 28 days relative to the control PLC.

Overall, use of hemp fiber produces mixtures with similar strength development. Use of low dosages of the Hemp A resulted in a moderate (20%, 1000 psi) increase in both early and later age strength, while higher dosages resulted in reduced strengths (−14%, ˜700 psi) relative to the control.

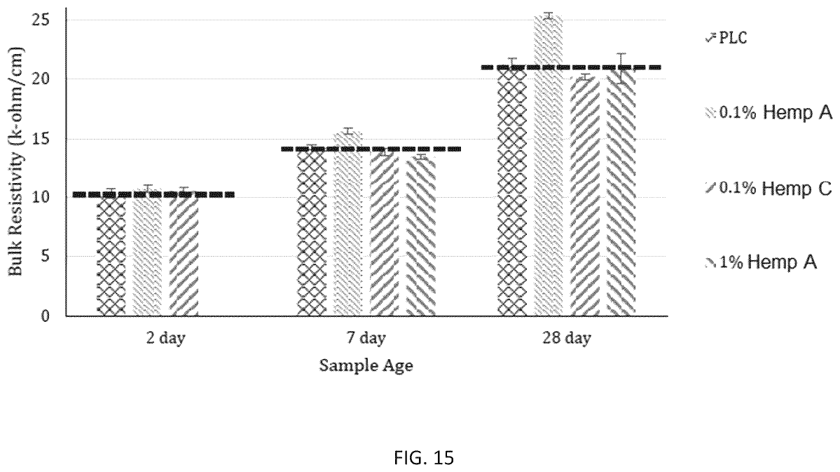

Electrical resistivity can be used to monitor changes in pore structure and hydration of cementitious mixtures.⁴⁸ As numbers or total volumes of pores are reduced through curing the resistivity of a sample will increase. Reduction in pores also results in reduced permeability and diffusivity of a concrete sample, leading to increased durability and service life with respect to infiltration of chlorides into the concrete and time until the initiation of corrosion. Shown in FIG. 15, bulk resistivity of the PLC and hemp samples was very similar for most samples. The exception to this is in the 0.1% Hemp A sample, which generated increasingly higher resistivity values with continued curing. Overall, this suggests that incorporation of hemp provides little impact on pore structure or durability.

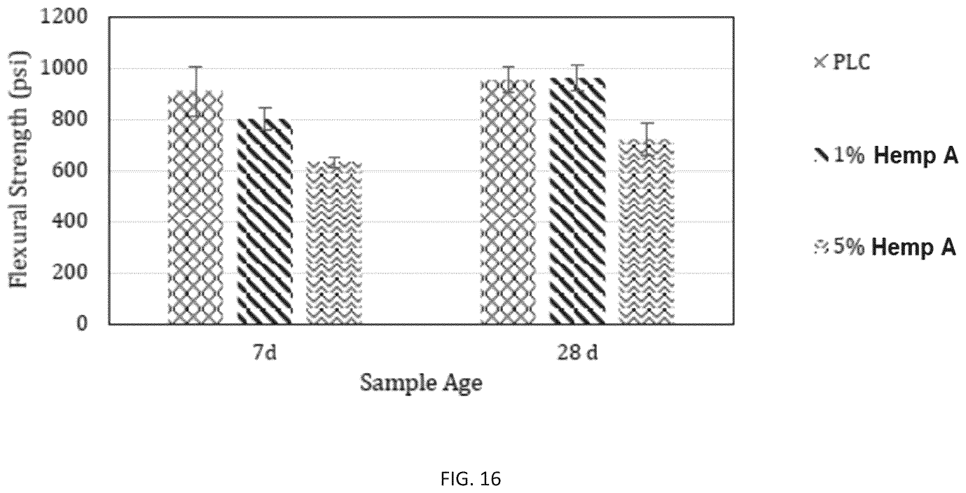

One of the goals of use of fibrous materials in concrete is increased flexural, also called bending, strength capacity. FIG. 16 shows the flexural strength of a PLC mortar and mortars containing 1% and 5% Hemp A fiber. Use of the 5% Hemp A fiber dosage resulted in ˜24% reduction in flexural strengths. Use of the 1% dosage of Hemp A fiber did not appear to have an impact on flexural strengths.

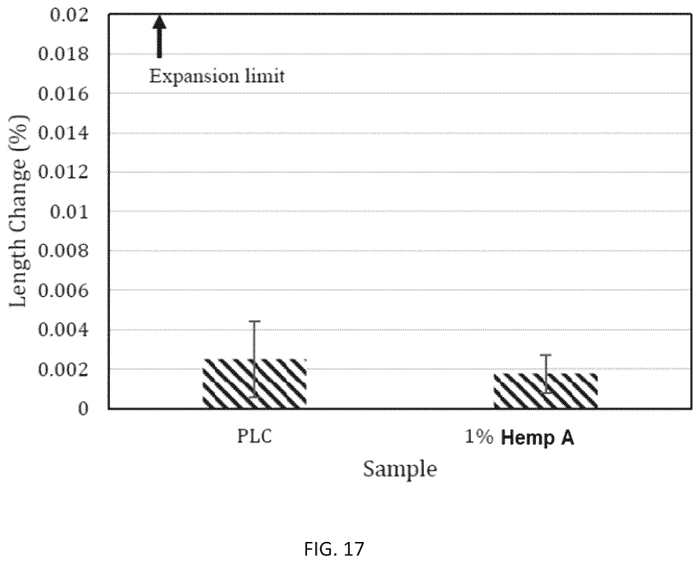

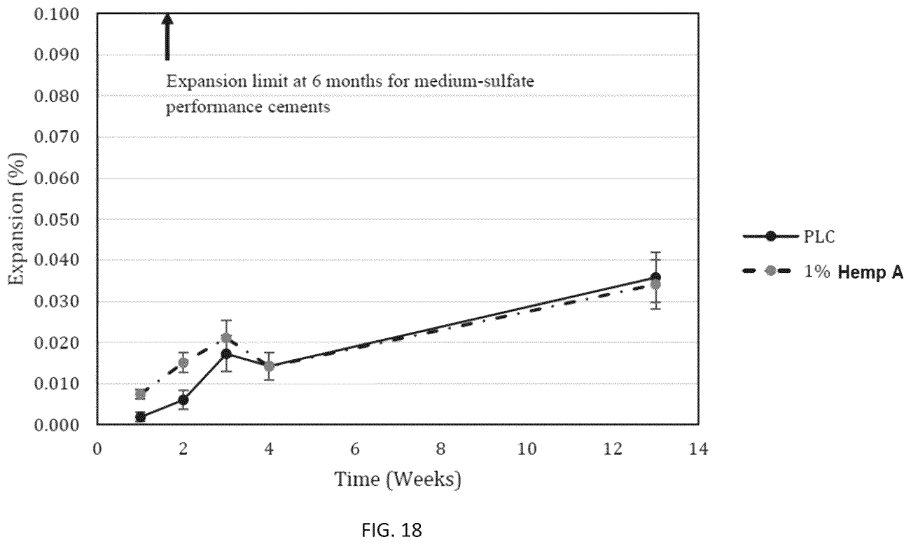

Mortars containing mineralized hemp fibers were exposed to water and sulfate solutions in order to determine their ability to resist expansion. See FIGS. 17 and 18. PLC and 1% Hemp A mixtures performed similarly in both tests. Both mixtures were well below the expansion limits required after 14 days in the water exposure test (ASTM C1038). After 3 months, both mixtures were also still below the 6-month expansion limit when exposed to sulfate solution. Overall, mixtures including a low dosage of mineralized hemp did not result in poorer sulfate resistance than control cement, but also did not appear to particularly improve sulfate resistance. However, sulfate resisting cements (Type II or Type V) can still be used where exposure to sulfates from soil or groundwater is anticipated.

### Discussion:

Effects observed when mineralized hemp fiber at dosages of 0.135% of the weight of the mixture's cement include: (1) acceleration of setting; (2) reduced flow (slump, in concrete; which can be addressed by use of a higher water-to-cement ratio or water reducing admixture in the concrete mixture) (3) moderate improvement in compressive strength; (4) no significant impact on flexural strength capacity at 7 and 28 days of curing; and (5) potential for improved durability. The mixture meet meets all tested requirements of the ASTM C1157 cement performance specification and appears usable as an alternative to typical Type I/II portland and PLC cements.

Although improvements in flexural capacity were not measured in the presently disclosed studies, it is believed that fibers likely provide early age tensile strength improvements in the paste. It is further believed that the use of hemp fibers can result in improvements in material toughness and reductions in early age plastic shrinkage cracking of concrete, which occurs within the first ˜8-12 hours of the concrete following placement. Concrete utilized for 3D printing has even greater susceptibility to drying and shrinkage cracking due to its high surface area, and thus could also be improved through use of hemp in the mortar or concrete mixtures.

Based on the mortar mixtures utilized in the present studies, the mixture proportions shown in Table 15, below, are suggested for use in full-scale concrete placements utilizing the mineralized hemp fibers. The mixture meets the minimum cement content (>639 lbs/cy) and maximum w/c (<0.426) requirements for an NC DOT class AA concrete.⁴⁷

TABLE 15
Recommended concrete mixture proportions.

| | Mixture | Assumed | Calculated Material |
|---|---|---|---|
| | Component | Material | Volume |
| | Weight | Specific | (cubic feet per cubic |
| Component | (lbs/cy) | Gravity | yard of concrete) |
| Cement | 650 | 3.15 | 3.31 |
| Hemp Fibers | 0.88 | 2.14 | 0.01 |
| Water | 277 | 1 | 4.44 |
| Coarse | 1825 | 2.5 | 11.70 |
| Aggregate | | | |
| Fine | 1225 | 2.6 | 7.55 |
| Aggregate | | | |
| w/c | 0.426 | | |
| | | Total volume (cf): | 27.00 |

### REFERENCES

All references listed herein including but not limited to all patents, patent applications and publications thereof, scientific journal articles, and database entries are incorporated herein by reference in their entireties to the extent that they supplement, explain, provide a background for, or teach methodology, techniques, and/or compositions employed herein.
1. Naka, K. & Chujo, Y. Control of Crystal Nucleation and Growth of Calcium Carbonate by Synthetic Substrates. Chem. Mater. 13, 3245 (2001).
2. Feng, Y., Cölfen, H. & Xiong, R. Organized mineralized cellulose nanostructures for biomedical applications. J. Mater. Chem. B 11, 5321 (2023).
3. Zhao, D. et al. Exploring structural variations of hydrogen-bonding patterns in cellulose during mechanical pulp refining of tobacco stems. Carbohydrate Polymers 204, 247 (2018).
4. Han, Z. et al. Effect of in situ deposition of calcium carbonate in cotton fiber on its mechanical properties. J of Applied Polymer Sci 140 (2022).
5. Kim, W., Hirasawa, I. & Kim, W. Polymorphic Change of Calcium Carbonate during Reaction Crystallization in a Batch Reactor. Ind. Eng. Chem. Res. 43,2650 (2004).
6. Raju, C. L., Narasimhulu, K. V., Gopal, N. O., Rao, J. L. & Reddy, B. C. V.

Electron paramagnetic resonance, optical and infrared spectral studies on the marine mussel Arca burnesi shells. J. Molecular Structure 608 (203), 201-211 (2002).
7. Wang, Y., Moo, Y. X., Chen, C., Gunawan, P. & Xu, R. Fast precipitation of uniform CaCO₃ nanospheres and their transformation to hollow hydroxyapatite nanospheres. Journal of Colloid and Interface Science 352, 393 (2010).
8. Al Omari, M., Rashid, I., Qinna, N., Jaber, A. M. & Badwan, A. Chapter Two—Calcium Carbonate in Profiles of Drug Substances, Excipients and Related Methodology 41, 31-132 (2016).
9. Butman, M. F. et al. Biomorphic Fibrous TiO₂ Photocatalyst Obtained by Hydrothermal Impregnation of Short Flax Fibers with Titanium Polyhydroxocomplexes. Catalysts 10, 541 (2020).
10. Zhang, Y. et al. In Situ Mineralizing Spinning of Strong and Tough Silk Fibers for Optical Waveguides. ACS Nano 17, 5905 (2023).
11. Wang, W., Dong, A. & Wen, Z. Preparation of a rough hydrophobic surface on jute fibers via silica hydrosol modification and properties of fiber-reinforced poylactic acid composites. Bio Res. 15(1), 290-301 (2020).
12. Shen, J., Smith, E., Chizyuka, M. & Prajapati, C. Development of durable shrink-resist coating of wool with sol-gel polymer processing. Fibers Polym 18, 1769 (2017).
13. European Patent Publication EP 3617396A4 to Fukuoka Moe, G. S. et al. Method for producing inorganic particle composite fibers.
14. PCT International Publication No. WO 2018/198884 to Fukuoka Moe, G. S. et al. Method for producing inorganic particle composite fibers (published Nov. 1, 2018).
15. John Murphy, Brandon M. Ross, Jessica M. Andriolo, Jack L. Skinner. Hybrid organic-inorganic perovskite composite fibers produced via melt electrospinning. J. Vac. Sci. Technol. B 34, 06KM01 (2016).
16. Lui, F. H. Y. et al. Microfluidic device with a carbonate-rich hydroxyapatite micro-coating. Nano 3, 1321-1336 (2022).
17. Ramachandran, A. et al. Modification of Fibers and Matrices in Natural Fiber Reinforced Polymer Composites: A Comprehensive Review. Macromol.Rapid Commun. 43, 2100862 (2022).
18. R. Prem Kumar, M. Muthukrishnan, A. Felix Sahayaraj. Effect of hybridization on natural fiber reinforced polymer composite materials—A review—Prem Kumar—2023 Polymer Composites—Wiley Online Library. (2023).
19. Kaushal, N. & Singh, A. K. Advancement in utilization of bio-based materials including cellulose, lignin, chitosan for bio-inspired surface coatings with special wetting behavior: A review on fabrication and applications. Int. J. Biol. Macromol. 246, 125709 (2023).
20. Bourbia, S., Kazeoui, H. & Belarbi. A review on recent research on bio-based building materials and their applications I Materials for Renewable and Sustainable Energy. 12, 117-139 (2023).
21. Elfaleh, I. et al. A comprehensive review of natural fibers and their composites: An eco-friendly alternative to conventional materials. Results in Engineering 19, 101271 (2023).
22. Ranjan, C., Sarkhel, G. & Kumar, K. Efficacy of natural fibre reinforced biodegradable composite towards industrial products—An extensive review. Materials Today: Proceedings 92, 1047-1054 (2023).
23. Rennan F. S. Barbosa, Rafaela R. Ferreira, Lucas R. Gongalves and Derval S. Rosa. in Cellulose Composites 1-20 (De Gruyter eBooks, 2023).
24. Ari, A., Karahan, M., Hasabo Abdelbagi, M. A., Babiker, O. & Ramazan Muhammed Ahmed Deh§ et. A Review of Cellulosic Natural Fibers' Properties and Their Suitability as Reinforcing Materials for Composite Panels and Applications. AATCC Journal of Research 10, 163-183 (2023).
25. Fang, W. et al. Organic-inorganic covalent-ionic molecules for elastic ceramic plastic. Nature 619, 293-299 (2023).
26. Zeng, G. et al. Natural organic-inorganic hybrid structure enabled green biomass adhesive with desirable strength, toughness and mildew resistance. Int.J.Biol.Macromol. 236, 123931 (2023).
27. Influence of silane modification on the properties of natural fibers and its effect on biocomposites 67-93 (Elsevier eBooks, 2022).
28. Prashantha Acharya, Dayananda Pai, G. T. Mahesha. Effect of chemical treatments on physical and mechanical characteristics of Helicteres isora natural fiber.

MaterialsToday: Proceedings, doi.org/10.1016/j.atpr.2023.03/432 (published online Mar. 30, 2023).
29. Ramakrishnan Thirumalaisamy, S. Senthil Kumar, Samson Jerold Samuel Chelladurai, S. Gnanasekaran, S. Sivananthan, N. K. Geetha, A. Ramesh, Gizachew Balcha Assefa. Study on Water Absorption Characteristics, Various Chemical Treatments, and Applications of Biological Fiber-Reinforced Polymer Matrix Composites. Journal of Nanomaterials 2023, U.S. Pat. No. 9,903,119 (2023).
30. Nidhi Shukla. Surface Treatment of Natural Fibers (Chemical Treatment), in Natural Fiber Composites, CRC Press, 1s Edition, 123-155 (2022).
31. Juvvi Siva Naga Raju, Melvin Victor Depoures, P. Kumaran. Comprehensive characterization of raw and alkali (NaOH) treated natural fibers from Symphirema involucraturn stem. Int. J. Biol. Macromol. 186, 886-896 (2021).
32. Tariq Altalhi Inamuddin, ed. Handbook of bioplastics & biocomposites engineering applications, Scrivener Publishing LLC, (2022).
33. Hammad Ahmad, Gyan Chhipi-Shrestha, Kasun Hewage, Rehan Sadiq. A Comprehensive Review on Construction Applications and Life Cycle Sustainability of Natural Fiber Biocomposites. Sustainability 14, 15905 (2022).
34. Ilyas, R. A. et al. in Biocomposite and Synthetic Composites for Automotive Applications (eds Sapuan, S. M. & Ilyas, R. A.) 51-105, Woodhead Publishing (2021).
35. ASTM International. (2024a). Standard Test Method for Bulk Electrical Resistivity or Bulk Conductivity of Concrete. ASTM C1876-24.
36. ASTM International. (2024b). Standard Test Method for Expansion of Hydraulic Cement Mortar Bars Stored in Water. ASTM C1038/C1038M-24.
37. ASTM International. (2024c). Standard Test Method for Length Change of Hydraulic-Cement Mortars Exposed to a Sulfate Solution. ASTM C1012/C1012M-24.
38. ASTM International. (2023a). Standard specification for compressive strength of hydraulic cement mortars (using 2-in. or [50-mm] cube specimens) (ASTM C595/C595M-23). ASTM International.
39. ASTM International. (2023b). Standard test method for compressive strength of hydraulic cement mortars (using 2-in. or [50-mm] cube specimens) (ASTM C109/C109M-23). ASTM International.
40. ASTM International. (2023c). Standard Test Method for Amount of Water Required for Normal Consistency of Hydraulic Cement Paste. ASTM C187-23.
41. ASTM International. (2022). Standard test method for density, relative density (specific gravity), and absorption of fine aggregate (ASTM C128-22). ASTM International.
42. ASTM International. (2021a). Standard specification for sand (ASTM C778-21). ASTM International.
43. ASTM International. (2021b). Standard test method for flexural strength of hydraulic-cement mortars (using simple beam with third-point loading) (ASTM C348-21). ASTM International.
44. ASTM International. (2021). Standard Test Methods for Time of Setting of Hydraulic Cement by Vicat Needle. ASTM C191-21.
45. ASTM International. (2020a). Standard specification for hydraulic cement (ASTM C1157/C1157M-20a). ASTM International.
46. ASTM International. (2020b). Standard test method for flow of hydraulic cement mortar (ASTM C1437-20). ASTM International.
47. North Carolina Department of Transportation. (2024). 2024 Standard Specifications for Roads and Structures.
48. Spragg, R., Bu, Y., Snyder, K., Bentz, D., & Weiss, J. Electrical testing of cement-based materials: Role of testing techniques, sample conditioning, and accelerated curing. Joint Transportation Research Program Report, doi.org/10/5703/1288284315230, (2014).

It will be understood that various details of the presently disclosed subject matter can be changed without departing from the scope of the presently disclosed subject matter. Furthermore, the foregoing description is for the purpose of illustration only, and not for the purpose of limitation.

What is claimed is:

1. A method of mineralizing a hemp fiber, wherein the method comprises:
(a) providing a hemp fiber for mineralization; and
(b) sequentially treating the hemp fiber with two aqueous solutions, wherein one of the two aqueous solutions comprises a calcium halide and wherein another of the two aqueous solutions comprises an alkali metal carbonate; thereby providing a hemp fiber mineralized with calcium carbonate.

2. The method of claim 1, wherein providing a hemp fiber comprises providing a decorticated hemp fiber.

3. The method of claim 2, wherein providing the hemp fiber comprises providing a degummed hemp fiber.

4. The method of claim 2, wherein providing the hemp fiber comprises opening, carding, or opening and carding the hemp fiber.

5. The method of claim 1, wherein the alkali metal carbonate is selected from sodium carbonate (Na₂CO₃), potassium carbonate (K₂CO₃), or cesium carbonate (Cs₂CO₃) and/or wherein the calcium halide is calcium chloride (CaCl₂).

6. The method of claim 1, wherein sequentially treating the hemp fiber with the two aqueous solutions comprising sequentially spraying the hemp fiber with the two aqueous solutions or sequentially dipping the hemp fiber into the two aqueous solutions.

7. The method of claim 1, wherein sequentially treating the hemp fiber with the two aqueous solutions comprises:
(b1) spraying the hemp fiber with the aqueous solution comprising the calcium halide, optionally about 140 millimolar (mM) CaCl₂, for a first period of time, optionally about 2 seconds to about 60 seconds;
(b2) waiting for a second period of time, optionally about 20 to 30 seconds;
(b3) spraying the hemp fiber with the aqueous solution comprising the alkali metal carbonate, optionally about 140 mM alkali metal carbonate, for a third period of time, optionally about 2 seconds to about 60 seconds;
(b4) waiting for a fourth period of time, optionally about 20 to 30 seconds; and
(b5) drying the hemp fiber for a fifth period of time, optionally for at least about 8 hours; optionally wherein the hemp fiber is positioned on a screen for steps (b1)-(b4) to allow the solutions to drain off the hemp fiber during the second and fourth periods of time.

8. A mineralized hemp fiber, wherein said mineralized hemp fiber comprises a cellulosic hemp fiber further comprising a coating comprising calcium carbonate deposited on the surface of the cellulosic hemp fiber.

9. The mineralized hemp fiber of claim 8, wherein the calcium carbonate comprises the calcite polymorph of calcium carbonate.

10. The mineralized hemp fiber of claim 8, wherein the mineralized hemp fiber is flame retardant and/or has improved water dispersibility compared to a corresponding non-mineralized fiber.

11. The mineralized hemp fiber of claim 8, wherein the mineralized hemp fiber has one or more of higher specific modulus, a higher tenacity, a higher strain at break, and a higher toughness compared to a corresponding non-mineralized hemp fiber.

12. A composition comprising the mineralized hemp fiber of claim 8, wherein the mineralized hemp fiber is embedded in an organic or inorganic polymeric matrix.

13. A composition comprising the mineralized hemp fiber of claim 8, and further comprising cement, optionally Portland cement, another hydraulic cement, or a blended cement, further optionally wherein the composition further comprises silica and/or water.

14. The composition of claim 13, further comprising one or more of sodium alginate fiber, a glucarate salt; and microcrystalline cellulose.

15. The composition of claim 13, wherein the composition is for use as a construction material, optionally for use as a three-dimensional printing construction material.

16. A non-cementitious composition comprising the mineralized hemp fiber of claim 8, optionally wherein the composition is for use in stucco or drywall applications.

17. A cementitious composition comprising the mineralized hemp fiber of claim 8.

18. A method of preparing a green concrete, wherein the method comprises:
(i) preparing a hemp fiber for mineralization;
(ii) mineralizing the hemp fiber via sequential treatment with an aqueous solution comprising a calcium halide and an aqueous solution comprising an alkali metal carbonate, thereby providing a mineralized hemp fiber;
(iii) preparing an aqueous dispersion of the mineralized hemp fiber, thereby providing a fiber slurry;
(iv) preparing a dispersion of the fiber slurry and cement, thereby providing a cement mixture; and
(v) molding or printing the cement mixture to provide a molded or printed green concrete object.

19. The method of claim 18, wherein step (i) comprises carding and/or opening the hemp fiber.

20. The method of claim 18, wherein step (i) comprises decorticating and/or degumming the hemp fiber.

21. The method of claim 18, wherein the mineralizing of step (ii) comprises spraying the hemp fiber sequentially with the aqueous solution comprising calcium chloride and the aqueous solution comprising an alkali metal carbonate or dipping the hemp fiber sequentially in the aqueous solution comprising calcium chloride and the aqueous solution comprising an alkali metal carbonate.
